(19) United States
(12) Patent Application Publication
(10) Pub. No.: US 2024/0034827 A1
(43) Pub. Date: Feb. 1, 2024

(54) AQUEOUS DISPERSION COMPRISING ALPHA EFFECT BASED NUCLEOPHILE

(71) Applicant: PPG Industries Ohio, Inc., Cleveland, OH (US)

(72) Inventors: Jonathan Garrett Weis, Allison Park, PA (US); Allison Brooks Domhoff, Pittsburgh, PA (US); Hongying Zhou, Allison Park, PA (US); Scott William Sisco, Glenshaw, PA (US); Paul Hubert Lamers, Allison Park, PA (US); Dennis Leroy Faler, North Huntingdon, PA (US); Tsukasa Mizuhara, Seven Valleys, PA (US); Gobinda Saha, Pittsburgh, PA (US)

(73) Assignee: PPG Industries Ohio, Inc., Cleveland, OH (US)

(21) Appl. No.: 18/256,456

(22) PCT Filed: Dec. 10, 2021
(86) PCT No.: PCT/US2021/062790

§ 371 Date: Jun. 8, 2023

Related U.S. Application Data
(60) Provisional application No. 63/123,550, filed on Dec. 10, 2020.

(51) Int. Cl. C08G 18/08; C08G 18/34; C08G 18/66; C08G 18/32; C08G 18/16

(52) U.S. Cl. CPC C08G 18/0866; C08G 18/348; C08G 18/6692; C08G 18/3231; C08G 18/3271; C08G 18/6685; C08G 18/6688; C08G 18/168; C08G 18/3206; C08G 18/3256; C08G 2150/00

(57) ABSTRACT

A film-forming thermoset coating composition includes: an aqueous medium; and Option 1 and/or Option 2 as follows: Option 1: a compound, such as an oligomeric or polymeric compound, including a plurality of alpha effect based nucleophile functional groups and/or linkages; and a component reactive with at least one of the alpha effect based nucleophile functional groups and/or linkages; Option 2: a compound, such as an oligomeric or polymeric compound including a plurality of n-methylolated alpha effect based nucleophile functional groups and/or linkages. The plurality of alpha effect based nucleophile functional groups and/or linkages include a semi-carbazide functional group and/or linkage, a carbazate functional group and/or linkage, an oxime functional group, an aminoxy functional group and/or linkage, or combinations thereof.

### FIELD OF THE INVENTION

The present invention relates to a film-forming thermoset coating composition, a substrate coated with a coating formed from such coating composition, as well as a multi-layer coating comprising a layer formed from such a coating composition and a process for the preparation of such coating composition.

### BACKGROUND OF THE INVENTION

Coatings are applied to a wide variety of substrates to provide color and other visual effects, corrosion resistance, abrasion resistance, chemical resistance, and the like.

Many automotive original equipment manufacturer (OEM) coatings, such as automotive basecoats, are curable at temperatures greater than 120° C., and it is difficult to achieve good curing at lower temperatures of 100° C. or less. Moreover, certain materials used in automotive components and coated with coating compositions cannot withstand curing at the higher temperatures without deforming, distorting, or otherwise degrading.

### SUMMARY OF THE INVENTION

The present invention is directed to a film-forming thermoset coating composition including: (a) an aqueous medium; and Option 1 and/or Option 2 as follows: Option 1: (b1) a compound including a plurality of alpha effect based nucleophile functional groups and/or linkages; and (c1) a component reactive with at least one of the alpha effect based nucleophile functional groups and/or linkages, where the component includes (i) formaldehyde, (ii) polyformaldehyde, (iii) a compound that generates formaldehyde, (iv) a polyfunctional ketone, (v) a polyfunctional aldehyde, or combinations thereof; Option 2: (b2) a compound including a plurality of n-methylolated alpha effect based nucleophile functional groups and/or linkages, where the plurality of alpha effect based nucleophile functional groups and/or linkages of (b1) and/or (b2) include a semi-carbazide functional group and/or linkage, a carbazate functional group and/or linkage, an oxime functional group, an aminoxy functional group and/or linkage, or combinations thereof.

The present invention is also directed to a process for the preparation of a film-forming thermoset coating composition, including: (A) mixing (c1) (i) formaldehyde, (ii) polyformaldehyde, (iii) a compound that generates formaldehyde, or combinations thereof, with (b1) a compound including a plurality of alpha effect based nucleophile functional groups and/or linkages, where the plurality of alpha effect based nucleophile functional groups and/or linkages include a semi-carbazide functional group and/or linkage, a carbazate functional group and/or linkage, an oxime functional group, an aminoxy functional group and/or linkage (B), or combinations thereof aging the mixture provided in step (A) for a time period to form the n-methylolated alpha effect based nucleophile functional groups and/or linkages, and (C) including the mixture obtained in step (B) into an aqueous medium in order to prepare a film-forming thermoset coating composition including an aqueous medium.

The present invention is also directed to a process for the preparation of a film-forming thermoset coating composition including: (A) mixing (c1) (i) formaldehyde, (ii) polyformaldehyde, (iii) a compound that generates formaldehyde, or combinations thereof, with a composition including (b1) a compound including a plurality of alpha effect based nucleophile functional groups and/or linkages, where the plurality of alpha effect based nucleophile functional groups and/or linkages include a semi-carbazide functional group and/or linkage, a carbazate functional group and/or linkage, an oxime functional group, an aminoxy functional group and/or linkage, or combinations thereof in order to prepare a film-forming thermoset coating composition including an aqueous medium, and (B) aging the mixture provided in step (A) for a time period to form the N-methylolated alpha effect based nucleophile functional groups and/or linkages in the oligomeric or polymeric compound.

The present invention is also directed to a film-forming thermoset coating composition including: (a) an aqueous medium; (b1) a compound including a plurality of alpha effect based nucleophile functional groups and/or linkages; and (c1) a component reactive with at least one of the alpha effect based nucleophile functional groups and/or linkages, where the component includes (i) formaldehyde, (ii) polyformaldehyde, (iii) a compound that generates formaldehyde, (iv) a polyfunctional ketone, (v) a polyfunctional aldehyde, or combinations thereof, where the plurality of alpha effect based nucleophile functional groups and/or linkages include a semi-carbazide functional group and/or linkage, a carbazate functional group and/or linkage, an oxime functional group, an aminoxy functional group and/or linkage, or combinations thereof.

The present invention is also directed to a film-forming thermoset coating composition, including: (a) an aqueous medium; and (b2) a compound including a plurality of n-methylolated alpha effect based nucleophile functional groups and/or linkages, where the plurality of alpha effect based nucleophile functional groups and/or linkages include a semi-carbazide functional group and/or linkage, a carbazate functional group and/or linkage, an oxime functional group, an aminoxy functional group and/or linkage, or combinations thereof.

### DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “an” acid, and the like refer to one or more of any of these items.

As used herein, a “film-forming resin” refers to a resin forming a self-supporting continuous film on at least a horizontal surface of a substrate upon removal of any diluents or carriers present in the composition or upon curing. Also, as used herein, the term “polymer” or “polymeric” is meant to refer to macromolecular compounds, i.e. compounds having a relatively high molecular mass (e.g., 500 Da or more), the structure of which comprises multiple repetition units derived, actually or conceptually, from chemical species of relatively lower molecular mass, and including prepolymers, oligomers, and both homopolymers and copolymers. The term “resin” is used interchangeably with “polymer”. The term “monomer” or “monomeric” is meant to refer to a compound which can contribute constitutional units to the structure of a polymer.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

As used herein, the terms “on”, “applied on/over”, “formed on/over”, “deposited on/over”, “overlay”, “provided on/over”, and the like mean applied, formed, overlaid, deposited, or provided on but not necessarily in contact with the surface. For example, a coating layer “applied over” a substrate does not preclude the presence of one or more other coating layers of the same or different composition located between the formed coating layer and the substrate.

The present invention is directed to a film-forming thermoset coating composition (hereinafter the “coating composition”) including: (a) an aqueous medium; and Option 1 and/or Option 2 as follows: Option 1: (b1) a compound including a plurality of alpha effect based nucleophile functional groups and/or linkages; and (c1) a component reactive with at least one of the alpha effect based nucleophile functional groups and/or linkages, where the component includes (i) formaldehyde, (ii) polyformaldehyde, (iii) a compound that generates formaldehyde, (iv) a polyfunctional ketone, (v) a polyfunctional aldehyde, or combinations thereof; Option 2: (b2) a compound including a plurality of n-methylolated alpha effect based nucleophile functional group and/or linkages, where the plurality of alpha effect based nucleophile functional groups and/or linkages of (b1) and/or (b2) include a semi-carbazide functional group and/or linkage, a carbazate functional group and/or linkage, an oxime functional group, an aminoxy functional group and/or linkage, or combinations thereof. The compound including a plurality of alpha effect based nucleophile functional groups and/or linkages (b1) and/or (b2) may be a monomeric, oligomeric or polymeric compound, such as an oligomeric or polymeric compound.

The coating composition includes an aqueous medium. As used herein, an “aqueous medium” refers to a liquid medium comprising at least 50 weight % water, based on the total weight of the liquid medium. As used herein, the term “liquid medium” is defined as water and organic solvents which are liquid at ambient temperature (20-25° C.) and volatile at 110° C. as measured by ASTM D2369-93. As such, it will be appreciated that the liquid medium does not include diluents which are liquid at ambient temperature but not volatile at 110° C. as measured by ASTM D2369-93. Such aqueous liquid mediums can for example comprise at least 60 weight % water, or at least 70 weight % water, or at least 80 weight % water, or at least 90 weight % water, or at least 95 weight % water, or 100 weight % water, based on the total weight of the liquid medium. The solvents that, if present, make up less than 50 weight % of the liquid medium include organic solvents. Non-limiting examples of suitable organic solvents include polar organic solvents, e.g. protic organic solvents such as glycols, glycol ether alcohols, alcohols, volatile ketones, glycol diethers, esters, and diesters. Other non-limiting examples of organic solvents include aromatic and aliphatic hydrocarbons.

The coating composition may include the components of Option 1, the components of Option 2, or a combination thereof. According to Option 1 and Option 2, the compound (b1) and/or (b2) comprises a plurality of alpha effect based nucleophile functional groups and/or linkages (Option 1) and/or a plurality of n-methylolated alpha effect based nucleophile functional groups and/or linkages (Option 2).

As used herein, the term “alpha effect based nucleophile” refers to a nucleophile having increased nucleophilicity of an atom due to the presence of an adjacent (alpha) atom having a lone pair of electrons. Non-limiting examples of alpha effect based nucleophiles include semi-carbazide functional groups and/or linkages, carbazate functional groups and/or linkages, oxime functional groups, and aminoxy functional groups and/or linkages.

Table A shows non-limiting examples of alpha effect based nucleophile functional groups and/or linkages. Any “R” group (e.g., R, R¹-Rⁿ, and the like) from this disclosure refers to any moiety unless specifically indicated otherwise, and wherein the R groups may be the same or different from one another. A suitable moiety may include any atom, such as a hydrogen atom, or group.

TABLE A

| | Functional Group | Linkage |
|---|---|---|
| Semi- carbazide Examples | 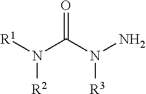 | 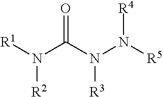 |
| | 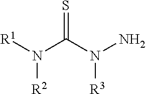 | 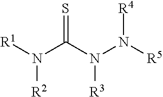 |
| Carbazate Example | 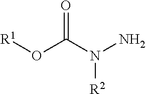 | 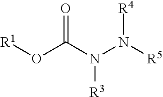 |
| Oxime Example | 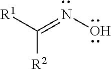 | N/A |
| Aminoxy Compound Example | 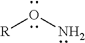 | 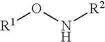 |

Based on Table A above, the compound (b1) and/or (b2), such as the compound (b1) and/or (b2), such as the oligomeric or polymeric compound (b1) and/or (b2) comprises a plurality of alpha effect based nucleophile functional groups and/or linkages. The alpha effect based nucleophile functional groups may react with the formaldehyde from at least one of the (i) formaldehyde, (ii) polyformaldehyde or (iii) compound that generates formaldehyde, and/or the (iv) polyfunctional ketone, and/or the (v) polyfunctional aldehyde of the component. The alpha effect based nucleophile functional linkages may react with the (i) formaldehyde, (ii) polyformaldehyde, (iii) compound that generates formaldehyde, or combinations thereof (e.g., not the (iv) polyfunctional ketone, and/or the (v) polyfunctional aldehyde). According to Option 1 as described hereinafter, the compound (b1), such as the oligomeric or polymeric compound (b1) comprising the plurality of alpha effect based nucleophile functional groups may react with the (i) formaldehyde, (ii) polyformaldehyde, formaldehyde of the (iii) compound that generates formaldehyde, (iv) polyfunctional ketone, (v) polyfunctional aldehyde, or combinations thereof, of the component in the coating composition to form a thermoset coating layer. The compound (b1), such as the oligomeric or polymeric compound (b1) comprising the plurality of alpha effect based nucleophile functional linkages may react with the (i) formaldehyde, (ii) polyformaldehyde, formaldehyde of the (iii) compound that generates formaldehyde, or combinations thereof, which resulting compound will undergo subsequent reactions to form a thermoset coating layer. For example, n-methylolated groups may form and then react with themselves or another compound (such as an aminoplast) to form a thermoset coating layer.

According to Option 2 as described hereinafter, the compound (b2), such as the oligomeric or polymeric compound (b2) comprising the plurality of n-methylolated alpha effect based nucleophile functional groups and/or linkages may then react with themselves or another compound (such as an aminoplast) to form a thermoset coating layer. The presence of the n-methylolated alpha effect based nucleophile functional groups and/or linkages may be identified based on the characteristic peaks generated using NMR spectroscopy.

An alpha effect based nucleophile material (e.g., alpha effect based nucleophile monomer, alpha effect based nucleophile polymer, alpha effect based nucleophile oligomer, alpha effect based nucleophile compound) refers to a material comprising at least one alpha effect based nucleophile functional group and/or linkage.

An n-methylolated alpha effect based nucleophile functional group and/or linkage refers to a functional group and/or linkage comprising an alpha effect based nucleophile which has been methylolated so as to contain a methylol group, such as a methylolated version of the alpha effect based nucleophiles from Table A. An n-methylolated alpha effect based nucleophile material (e.g., n-methylolated alpha effect based nucleophile monomer, n-methylolated alpha effect based nucleophile polymer, n-methylolated alpha effect based nucleophile oligomer, n-methylolated alpha effect based nucleophile compound) refers to a material comprising at least one n-methylolated alpha effect based nucleophile functional group and/or linkage.

As used herein, the term “hydrazine functional group and/or linkage” refers to a functional group and/or linkage having two adjacent nitrogen atoms connected by a single bond. A hydrazine functional material (e.g., hydrazine functional monomer, hydrazine functional polymer, hydrazine functional oligomer, hydrazine functional compound) refers to a material comprising at least one hydrazine functional group and/or linkage.

For example, a hydrazine functional material may comprise a group having the following structure (I):

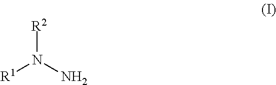

For example, a hydrazine functional material may comprise a group having the following structure (II):

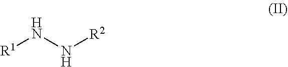

The alpha effect based nucleophile functional group and/or linkage may comprise a semi-carbazide functional group and/or linkage. For example, a hydrazine functional material may comprise a semi-carbazide group resulting from the reaction of hydrazine and isocyanate or an isothiocyanate having the following structure (IIIa) or (IIIb) (also a hydrazine). Structure (IIIa) shows the semi-carbazide structure resulting from the reaction of hydrazine and isocyanate. Structure (IIIb) shows the semi-carbazide structure (a thio semi-carbazide) resulting from the reaction of hydrazine with isothiocyanate, such that the carbonyl carbon from (IIIa) is instead a carbon atom double bonded to a sulfur atom (a thiocarbonyl). A semi-carbazide functional material (e.g., semi-carbazide functional monomer, semi-carbazide functional polymer, semi-carbazide functional oligomer, semi-carbazide functional compound) refers to a material comprising at least one semi-carbazide functional group and/or linkage. It will be appreciated the term “semi-carbazide” used herein refers to both species of semi-carbazide from structures (IIIa) and (IIIb) as well as to semicarbazone structures:

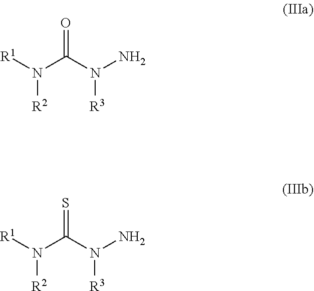

For example, a hydrazine functional material may comprise a group resulting from the reaction of hydrazine with a ketone or aldehyde group having the following structure (IV) (also a hydrazine):

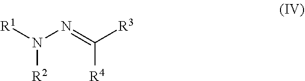

For example, a hydrazine functional material may comprise a group resulting from the reaction of hydrazine with acrylate via aza-Michael addition having the following structure (V) (also a hydrazine):

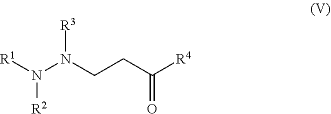

For example, a hydrazine functional material may comprise a group resulting from the product of isocyanate and hydrazine with aza-Michael addition to acrylate having the following structure (VI) (also a hydrazine and a semi-carbazide linkage):

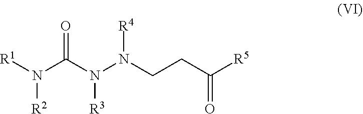

For example, the hydrazine functional material may comprise a methylolated hydrazine, and the methylolated hydrazine may have the following structure (VII):

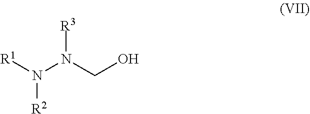

It will be appreciated that R² from structure (VII) could additionally comprise a methylol group or could alternatively comprise the methylol group.

For example, the hydrazine functional material may comprise a methylolated semi-carbazide. The semi-carbazide functional material may comprise a methylolated semi-carbazide.

The hydrazine functional material may comprise a pendant and or a terminal and/or an internal hydrazine functional group and/or linkage. A terminal hydrazine functional group and/or linkage is a hydrazine functional group and/or linkage located at a terminal location of the backbone of the hydrazine functional material. An internal hydrazine functional group and/or linkage is a hydrazine functional group and/or linkage located at a non-terminal location along the backbone of the hydrazine functional material. A pendant hydrazine functional group and/or linkage is a hydrazine functional group and/or linkage bonded to but not a part of the backbone of the hydrazine functional material.

The semi-carbazide functional material may comprise a pendant and/or a terminal and/or an internal semi-carbazide functional group and/or linkage. A terminal semi-carbazide functional group and/or linkage is a semi-carbazide functional group and/or linkage located at a terminal location of the backbone of the semi-carbazide functional material. An internal semi-carbazide functional group and/or linkage is a semi-carbazide functional group and/or linkage located at a non-terminal location along the backbone of the semi-carbazide functional material. A pendant semi-carbazide functional group and/or linkage is a semi-carbazide functional group and/or linkage bonded to but not a part of the backbone of the semi-carbazide functional material.

The alpha effect based nucleophile functional group and/or linkage may comprise a carbazate functional group and/or linkage. A carbazate functional material (e.g., carbazate functional monomer, carbazate functional polymer, carbazate functional oligomer, carbazate functional compound) refers to a material comprising at least one carbazate functional group and/or linkage. For example, a carbazate functional material may comprise a group having the following structure (VIII):

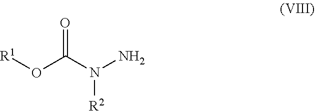

The carbazate functional material may be methylolated. One non-limiting example of a methylolated carbazate functional material is shown in structure (VIIIa):

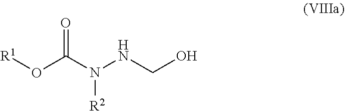

The carbazate functional material may comprise a pendant and/or a terminal and/or an internal carbazate functional group and/or linkage. A terminal carbazate functional group and/or linkage is a carbazate functional group and/or linkage located at a terminal location of the backbone of the carbazate functional material. An internal carbazate functional group and/or linkage is a carbazate functional group and/or linkage located at a non-terminal location along the backbone of the carbazate functional material. A pendant carbazate functional group and/or linkage is a carbazate functional group and/or linkage bonded to but not a part of the backbone of the carbazate functional material.

The alpha effect based nucleophile functional group may comprise an oxime functional group. An oxime functional material (e.g., oxime functional monomer, oxime functional polymer, oxime functional oligomer, oxime functional compound) refers to a material comprising at least one oxime functional group and/or linkage. For example, an oxime functional material may comprise a group having the following structure (IX):

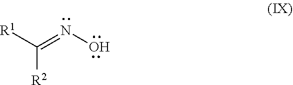

The oxime functional material may be methylolated. One non-limiting example of a methylolated oxime functional material is shown in structure (IXa):

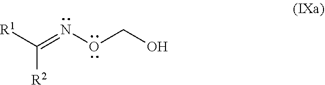

The oxime functional material may comprise a terminal and/or a pendant oxime functional group. A terminal oxime functional group is an oxime functional group located at a terminal location of the backbone of the oxime functional material. A pendant oxime functional group is an oxime functional group bonded to but not a part of the backbone of the oxime functional material.

An oxime linkage may be formed based on the following reaction (IXb), by reacting keto or aldo functionality with an aminoxy:

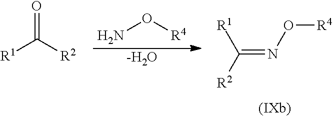

The alpha effect based nucleophile functional group and/or linkage may comprise an aminoxy functional group and/or linkage. An aminoxy functional material (e.g., aminoxy functional monomer, aminoxy functional polymer, aminoxy functional oligomer, aminoxy functional compound) refers to a material comprising at least one aminoxy functional group and/or linkage. For example, an aminoxy functional material may comprise a group having the following structure (X):

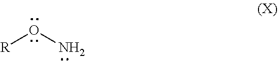

The aminoxy functional material may be methylolated. One non-limiting example of a methylolated aminoxy functional material is shown in structure (Xa):

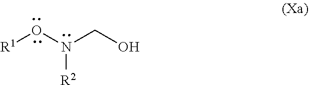

The aminoxy functional material may comprise a terminal and/or a pendant aminoxy functional group and/or linkage. A terminal aminoxy functional group and/or linkage is an aminoxy functional group and/or linkage located at a terminal location of the backbone of the aminoxy functional material. A pendant aminoxy functional group and/or linkage is an aminoxy functional group and/or linkage bonded to but not a part of the backbone of the aminoxy functional material.

The alpha effect based nucleophile functional group and/or linkage may comprise at least one of the following structures:

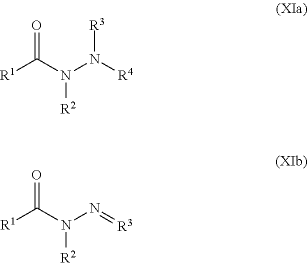

wherein R₁ comprises a nitrogen or oxygen containing group, wherein a nitrogen or oxygen atom of the nitrogen or oxygen containing group is bonded directly to the carbonyl carbon bonded to R₁, wherein R²-R⁴ comprise any suitable moiety (consistent with a carbazate functional group and/or linkage (including an oxygen atom) or hydrazine functional group and/or linkage having a semi-carbazide structure (including a nitrogen atom)). At least one of R², R³, and/or R may be a hydrogen atom in structure (XIa), and wherein R² may be a hydrogen atom in structure (XIb).

The structures (XIa) and (XIb) may be methylolated, such as R², R³, and/or R⁴ comprising a methylol group in structure (XIa) and/or R² comprising a methylol group in structure (XIb).

As used herein, the term “hydrazone linkage” refers to a compound containing the following structure (XII):

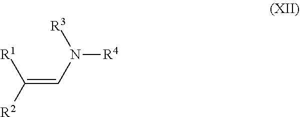

A hydrazone linkage may be formed based on the following reaction (XIII):

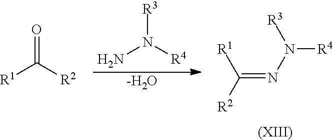

It will be appreciated that the product from reaction (XIII) may include the cis and/or trans isomers (i.e., the Z and/or E isomers) of the hydrozones.

According to Option 1, the coating composition includes (b1) a compound, such as an oligomeric or polymeric compound, comprising a plurality of alpha effect based nucleophile functional groups and/or linkages. The (b1) oligomeric or polymeric compound may comprise any suitable oligomer or polymer.

The compound (b1), such as the oligomeric or polymeric compound (b1), may comprise any of the above-described alpha effect based nucleophile functional groups and/or linkages. The compound (b1), such as the oligomeric or polymeric compound (b1) may comprise a semi-carbazide functional group and/or linkage, a carbazate functional group and/or linkage, an oxime functional group, an aminoxy functional group and/or linkage, or combinations thereof. The plurality of alpha effect based nucleophile functional groups and/or linkages may comprise at least two of the same alpha effect based nucleophile functional groups and/or linkages. The plurality of alpha effect based nucleophile functional groups and/or linkages may comprise at least two different alpha effect based nucleophile functional groups and/or linkages. For example, the compound (b1), such as the oligomeric or polymeric compound (b1), may comprise both a carbazate and a semi-carbazide alpha effect based nucleophile functional group and/or linkage. The compound (b1), such as the oligomeric or polymeric compound (b1), may comprise both a carbazate alpha effect based nucleophile functional group and/or linkage and oxime alpha effect based nucleophile functional group. The compound (b1), such as the oligomeric or polymeric compound (b1), may comprise both a carbazate and an aminoxy alpha effect based nucleophile functional group and/or linkage. The compound (b1), such as the oligomeric or polymeric compound (b1), may comprise both a semi-carbazide alpha effect based nucleophile functional group and/or linkage and oxime alpha effect based nucleophile functional group. The compound (b1), such as the oligomeric or polymeric compound (b1), may comprise both a semi-carbazide and an aminoxy alpha effect based nucleophile functional group and/or linkage. The compound (b1), such as the oligomeric or polymeric compound (b1), may comprise both an aminoxy alpha effect based nucleophile functional group and/or linkage and oxime alpha effect based nucleophile functional group. The compound (b1), such as the oligomeric or polymeric compound (b1), may comprise both an aminoxy alpha effect based nucleophile functional group and/or linkage and oxime alpha effect based nucleophile functional group. The compound (b1), such as the oligomeric or polymeric compound (b1), may comprise a semi-carbazide and carbazate alpha effect based nucleophile functional group and/or linkage and oxime alpha effect based nucleophile functional group. The compound (b1), such as the oligomeric or polymeric compound (b1), may comprise a semi-carbazide and aminoxy alpha effect based nucleophile functional group and/or linkage and oxime alpha effect based nucleophile functional group. The compound (b1), such as the oligomeric or polymeric compound (b1), may comprise an aminoxy and carbazate alpha effect based nucleophile functional group and/or linkage and oxime alpha effect based nucleophile functional group. The compound (b1), such as the oligomeric or polymeric compound (b1), may comprise a semi-carbazide, carbazate, and aminoxy alpha effect based nucleophile functional group and/or linkage. The compound (b1), such as the oligomeric or polymeric compound (b1), may comprise a semi-carbazide, carbazate, and aminoxy alpha effect based nucleophile functional group and/or linkage and oxime alpha effect based nucleophile functional group.

The alpha effect based nucleophile functional compound, such as the alpha effect based nucleophile functional oligomeric or polymeric compound may comprise a semi-carbazide functional compound, such as a semi-carbazide functional oligomeric or polymeric compound. The semi-carbazide functional compound, such as the semi-carbazide functional oligomeric or polymeric compound may be prepared by reacting an isocyanate functional compound with hydrazine and/or aqueous hydrazine. The isocyanate functional compound may comprise an isothiocyanate functional compound.

The alpha effect based nucleophile functional compound, such as the alpha effect based nucleophile functional oligomeric or polymeric compound may comprise a carbazate functional compound, such as a carbazate functional compound. The carbazate functional compound, such as a carbazate functional oligomeric or polymeric compound may be prepared by reacting an isocyanate functional compound with a polycarbazate. The carbazate functional compound, such as a carbazate functional oligomeric or polymeric compound may be prepared by reacting a carbonate functional compound with hydrazine.

The alpha effect based nucleophile functional compound, such as the alpha effect based nucleophile functional oligomeric or polymeric compound may comprise an oxime functional compound, such as a oxime functional compound. The oxime functional compound, such as an oxime functional oligomeric or polymeric compound may be prepared by reacting an isocyanate functional compound with a polyoxime compound. The oxime functional compound, such as an oxime functional oligomeric or polymeric compound may be prepared by condensing a polyketone functional compound with hydroxylamine.

The alpha effect based nucleophile functional compound, such as the alpha effect based nucleophile functional oligomeric or polymeric compound may comprise an aminoxy functional compound. The aminoxy functional compound, such as a aminoxy functional oligomeric or polymeric compound may be prepared by reacting an isocyanate functional compound with a polyaminoxy compound. A non-limiting example of the aminoxy functional compound comprises 0,0′-1,3-propanediylbishydroxylamine dihydrochloride.

The isocyanate functional compound may be reacted with mixtures of the above so as to include some combination of alpha effect based nucleophile functional groups and/or linkages. For example, the isocyanate functional compound may be reacted with hydrazine and polycarbonate to form a compound having both semi-carbazide and carbazate functional groups and/or linkages.

Reacting the isocyanate functional compound with a compound comprising a plurality of alpha effect based nucleophile functional groups and/or linkages can also chain extend and/or terminally cap the isocyanate functional compound and introduce alpha effect based nucleophile functional groups and/or linkages onto the compound.

When the alpha effect based nucleophile functional compound, such as the alpha effect based nucleophile functional oligomeric or polymeric compound (e.g., the later described polyurethane-acrylate core-shell particles comprising a polymeric acrylic core at least partially encapsulated by a polymeric shell comprising urethane linkages, wherein the polymeric shell comprises the plurality of alpha effect based nucleophile functional groups and/or linkages) is prepared, the resulting mixture may comprise excess residual unreacted alpha effect based nucleophile functional groups and/or linkages. The use of excess alpha effect based nucleophile functional groups and/or linkages may result in the oligomeric or polymeric compound comprising at least one terminal alpha effect based nucleophile functional group and/or linkage. Moreover, some residual unreacted alpha effect based nucleophile functional groups and/or linkages may remain in the mixture, which can participate in a curing reaction, such as with formaldehyde.

The compound (b1), such as the oligomeric or polymeric compound (b1) may comprise an acid functional group (instead of or in addition to (c1) comprising an acid functional group). The acid functional group may render (b1) and/or (c1) water dispersible.

The compound (b1), such as the oligomeric or polymeric compound (b1) may comprise a polyurethane dispersion. As used herein, the term “dispersion” refers to a two-phase system in which one phase includes finely divided particles distributed throughout a second phase, which is a continuous phase. The continuous phase may comprise the aqueous medium, in which the polymeric particles (e.g., (b1) and/or (c1)) are suspended therein. The particles may have an average particle size of from 20 to 2000 nm, such as from 50 to 1000 nm, from 50 to 500 nm, from 50 to 200 nm, from 70 to 150 nm, or from 80 to 150 nm, as determined with a Zetasizer 3000HS following the instructions in the Zetasizer 3000HS manual. As used herein, “average particle size” refers to volume average particle size.

The polyurethane dispersion may comprise polycarbazate and/or polyaminoxy functionality as the alpha effect based nucleophile functional groups and/or linkages. The polyurethane dispersion may comprise poly-semi-carbazide functionality as the alpha effect based nucleophile functional groups and/or linkages.

The compound (b1), such as the oligomeric or polymeric compound (b1) may comprise a polyacrylic dispersion. The polyacrylic dispersion may comprise polycarbazate and/or polyaminoxy functionality as the alpha effect based nucleophile functional groups and/or linkages.

The compound (b1), such as the oligomeric or polymeric compound (b1) may comprise a combination of a polyacrylic dispersion and polyurethane dispersion, such as a blend of polyurethane polymers with polyacrylic polymers and/or polyurethane acrylate copolymers.

The compound (b1), such as the oligomeric or polymeric compound (b1) may comprise a latex, such as an acrylic latex, a polyurethane latex, or some combination thereof. The compound (b1), such as the oligomeric or polymeric compound (b1) may comprise an emulsion polymer or oligomer. The compound (b1), such as the oligomeric or polymeric compound (b1) may comprise a water dispersible polyester, or other water dispersible oligomer or polymer. The compound (b1), such as the oligomeric or polymeric compound (b1) may comprise an at least partially or a fully water dispersible oligomer or polymer.

The compound (b1), such as the oligomeric or polymeric compound (b1) may comprise a compound comprising aminoxy functional groups and/or linkages and can be prepared as follows.

Monomers may be synthesized by alkylation of allyl chloride or chloromethyl-styrene using methylethyl ketone oxime (MEKO). The subsequent MEKO-substituted monomer can be hydrolyzed to form the amino-oxy monomer. This monomer can then be polymerized to form the compound comprising aminoxy functional groups and/or linkages.

Alternatively, the MEKO-substituted monomer can also be polymerized. Then the subsequent polymer containing MEKO groups can be hydrolyzed.

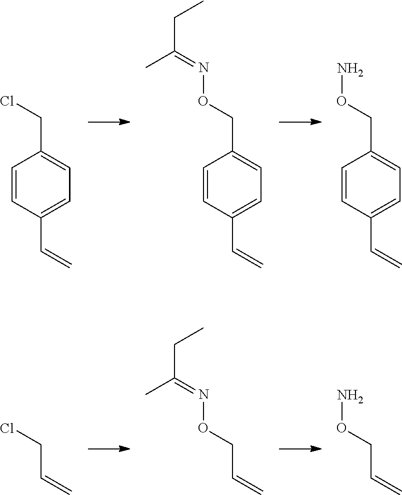

Further, molecules containing leaving groups such as halides, tosylates, mesylates can be reacted with MEKO via Williamson Ether synthesis conditions to yield O-substituted oximes. The resulting oxime can be hydrolyzed to the O-substituted hydroxyl amine compound, as shown below.

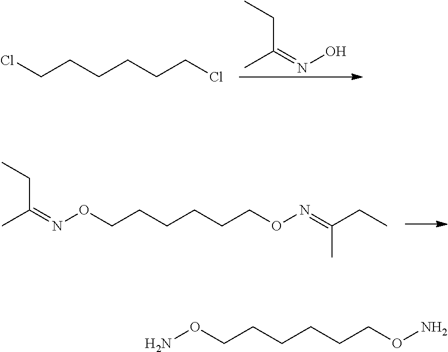

Molecules containing hydroxyl groups can be esterified with the molecule (Boc-aminoxy) acetic acid. The resulting (Boc-aminoxy) acetic ester can be deprotected under acidic conditions to form the aminoxy group. Alternatively molecules containing hydroxy groups can be reacted with MEKO via the Mitsunobu reaction to provide the O-substituted oxime which can be further hydrolyzed to the O-substituted hydroxylamine, as shown below.

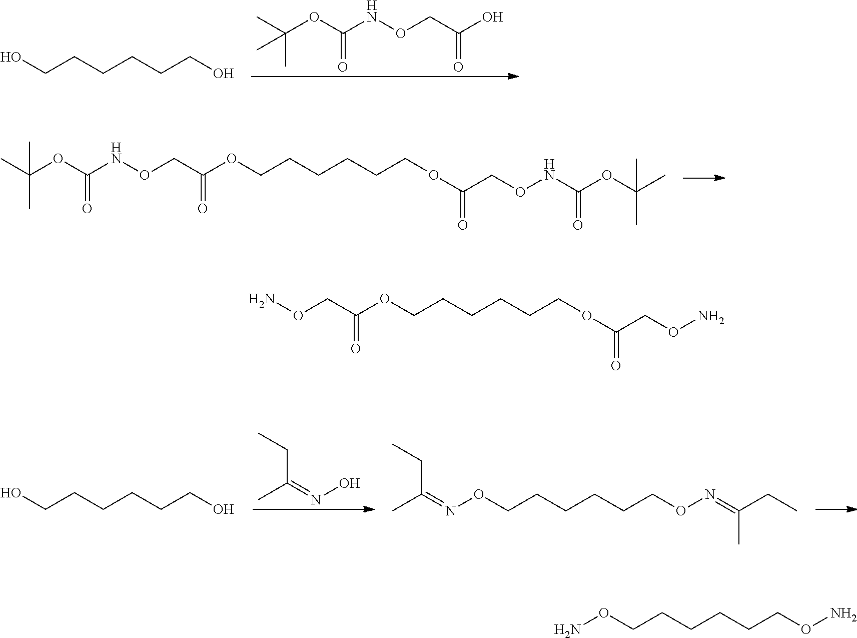

Molecules containing epoxy groups can be reacted with the molecule (Boc-aminoxy) acetic acid. The resulting (Boc-aminoxy) acetic ester can be deprotected under acidic conditions to form the aminoxy group, as shown below.

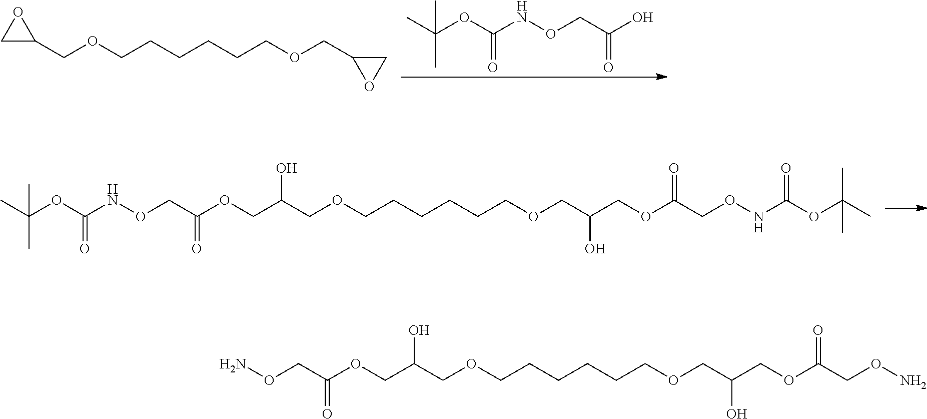

Molecules containing hydroxyl groups can be reacted with monochloroamine or hydroxylamine-O-sulfonic acid in the presence of a strong base such as metal alkoxide to form the resulting O-substituted hydroxylamine, as shown below.

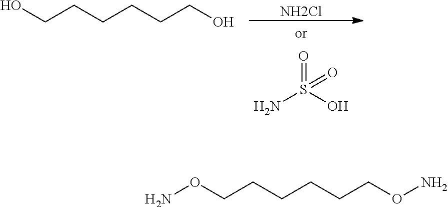 [SMILES: OCCCCCCO ; "NH2Cl" ; NS(=O)(=O)O ; NOCCCCCCON]

Molecules containing hydroxy groups can be reacted with N-hydroxyl phthalimide or N-hydroxyl succinimide via the Mitsunobu reaction to yield the O-substituted phthalimide or succinimide. This resulting intermediate can be further elaborated to the O-substituted hydroxylamine by reaction with hydrazine. Alternatively the phthalimide or succinimide intermediate can be accessed by reaction of molecules containing leaving groups (halides, tosylates, etc.) with N-hydroxyl phthalimide or succinimide under Williamson ether reaction conditions.

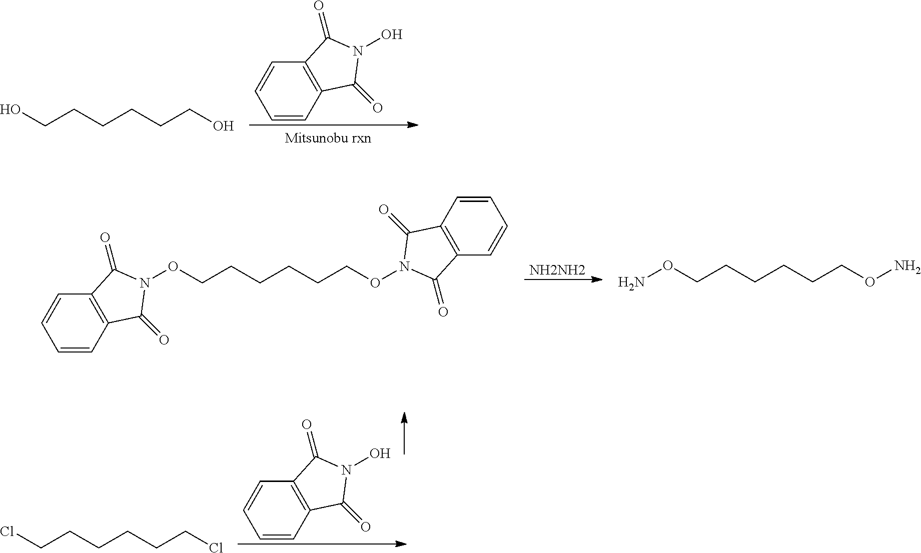

Reaction of a polyanhydride with MEKO can yield the MEKO half-acid half-ester. Subsequent hydrolysis of the oxime will yield an O-hydroxyamic acid, as shown below.

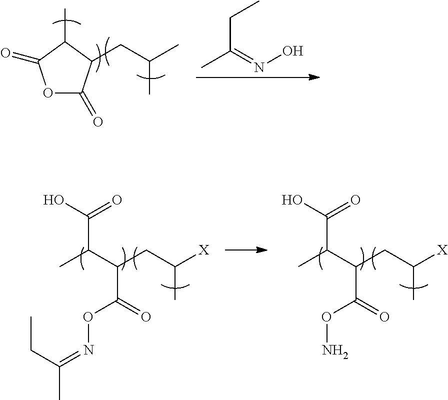

Reaction of a polyisocyanate with MEKO can yield the MEKO polyurethane. Subsequent hydrolysis of the oxime will yield an O-hydroxyamic acid urethane. The reaction product of IPDI is shown as an example but polyfunctional isocyanates can be used with functionality >2, as shown below.

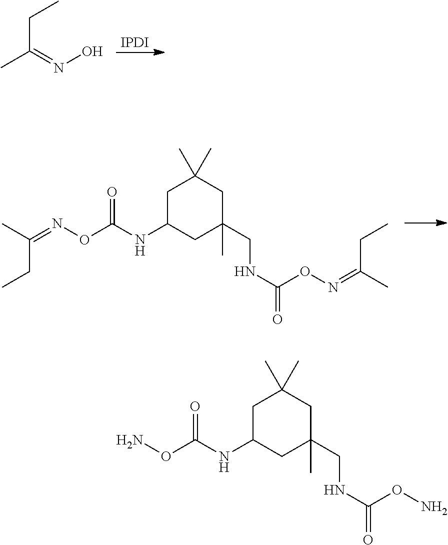

A polymer containing halide groups such as poly(chloromethyl styrene) can be alkylated using MEKO. The subsequent MEKO-substituted polymer can be hydrolyzed to yield the aminoxy polymer. Various copolymers containing halide groups can be utilized in this approach, as shown below.

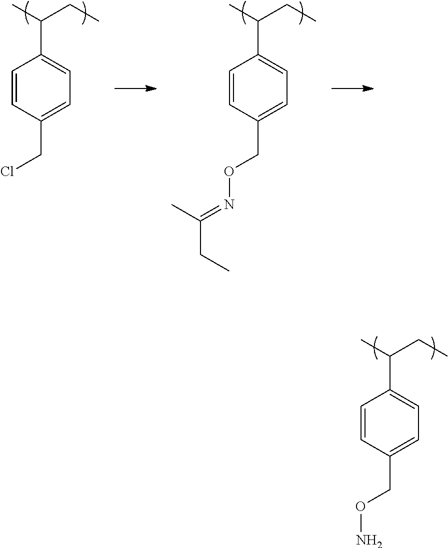

The compound (b1), such as the oligomeric or polymeric compound (b1) may comprise polyurethane-acrylate core-shell particles comprising a polymeric acrylic core at least partially encapsulated by a polymeric shell comprising urethane linkages, wherein the polymeric shell comprises the plurality of alpha effect based nucleophile functional groups and/or linkages, wherein the polymeric shell is covalently bonded to at least a portion of the polymeric core. The polyurethane-acrylate core-shell particles may comprise an acid-functional group on the polymeric shell.

The polymeric core and/or the polymeric shell of the polyurethane-acrylate core-shell particles may comprise one or more, such as two or more, additional reactive functional groups (in addition to the alpha effect based nucleophile functional group and/or linkage). The term “reactive functional group” refers to an atom, group of atoms, functionality, or group having sufficient reactivity to form at least one covalent bond with another co-reactive group in a chemical reaction. Suitable additional reactive functional groups that can be formed on the polymeric shell and/or polymeric core include carboxylic acid groups, amine groups, epoxide groups, hydrazide groups, hydroxyl groups, thiol groups, carbamate groups, amide groups, urea groups, isocyanate groups (including blocked isocyanate groups), ethylenically unsaturated groups, or a combination thereof. As used herein, “ethylenically unsaturated” refers to a group having at least one carbon-carbon double bond.

The polyurethane-acrylate core-shell particles may comprise a polymeric acrylic core at least partially encapsulated by a polymeric shell comprising urethane linkages. The polymeric shell may include an acid functional group and two or more alpha effect based nucleophile functional groups and/or linkages. The polymeric shell is covalently bonded to at least a portion of the polymeric core. As used herein, “polymeric core” means that the core of the core-shell particle comprises one or more polymers, and a “polymeric shell” means that the shell of the core-shell particle comprises one or more polymers. The polymeric core may be at least partially encapsulated by the polymeric shell to form the core-shell particle. Further, the core-shell particles can have various shapes (or morphologies) and sizes. The core-shell particles can have generally spherical, cubic, platy, polyhedral, or acicular (elongated or fibrous) morphologies. The core-shell particles can also have an average particle size of 30 to 300 nanometers, or from 40 to 200 nanometers, or from 50 to 150 nanometers. As used herein, “average particle size” refers to volume average particle size. The average particle size is determined with a Zetasizer 3000HS following the instructions in the Zetasizer 3000HS manual.

The polymeric acrylic core of the polyurethane-acrylate core-shell particles can comprise an addition polymer formed from ethylenically unsaturated monomers. Suitable ethylenically unsaturated groups include, but are not limited to, (meth)acrylate groups, vinyl groups, or a combination thereof. As used herein, the term “(meth)acrylate” refers to both the methacrylate and the acrylate.

The polymeric shell of the polyurethane-acrylate core-shell particles may comprise urethane linkages and may comprise an acid functional group and two or more alpha effect based nucleophile functional groups and/or linkages.

The backbone or main chain of a polymer that forms at least a portion of the polymeric shell comprises urethane linkages and, optionally, other linkages. The “backbone or main chain” of the shell polymer refers to the longest series of covalently bonded atoms that together creates the continuous chain of the shell polymer. The backbone or main chain of a polymer that forms at least a portion of the polymeric shell may comprise urea linkages. For instance, the polymeric shell can comprise a polyurethane with a backbone that includes urethane linkages (—NH—C(═O)—O—) and optionally urea linkages (—NH—C(═O)—NH—). The polymeric shell can also comprise additional linkages including, but not limited to, ester linkages, ether linkages, or a combination thereof.

The core-shell particles can be prepared to provide a hydrophilic polymeric shell with enhanced water-dispersibility/stability and a hydrophobic polymeric core. As such, the polymeric shell can comprise hydrophilic water-dispersible groups while the polymeric core can be free of hydrophilic water-dispersible groups. The hydrophilic water-dispersible groups can increase the water-dispersibility/stability of the polymeric shell in the aqueous medium so that the polymeric shell at least partially encapsulates the hydrophobic core.

The water-dispersible groups can be formed from hydrophilic functional groups. Suitable examples of hydrophilic functional groups include carboxylic acid functional groups. The polymeric shell may comprise carboxylic acid functional groups, such as by using a carboxylic acid group containing diols to form the polymeric shell. The carboxylic acid functional groups can be at least partially neutralized to form a salt (i.e., at least 30% of the total neutralization equivalent) by an organic or inorganic base, such as a volatile amine, to form a salt group. The amine may comprise a primary amine, a secondary amine, a tertiary amine, or a combination thereof. Suitable amines include ammonia, dimethylamine, trimethylamine, triethylamine, monoethanolamine, and dimethylethanolamine. It is appreciated that the amines may be at least partially evaporated during the formation of the coating to expose the carboxylic acid functional groups and allow the carboxylic acid functional groups to undergo further reactions such as with a crosslinking agent reactive with the carboxylic acid functional groups. Other water-dispersible groups that may be present in the polymeric shell include polyoxyalkylene groups.

The polymeric shell may include a polyurethane with two or more alpha effect based nucleophile functional groups and/or linkages as well as at least one pendant and/or terminal carboxylic acid functional group. The alpha effect based nucleophile functional groups and/or linkages may be pendant (e.g., to the polyurethane shell) and/or terminal (e.g., on the backbone of the polyurethane shell) and/or internal such as to be positioned in the polymeric backbone at a non-terminal location (e.g., of the polyurethane shell). The polyurethane-acrylate core-shell particles, such as the shell thereof, may comprise internal alpha effect based nucleophile functional groups and/or linkages that provide at least 2 secondary amino groups on the polyurethane-acrylate core-shell particles. The secondary amino groups may be reactive with formaldehyde. The carboxylic acid functional groups can be at least partially neutralized to form a salt (i.e., at least 30% of the total neutralization equivalent) by an organic or inorganic base, such as a volatile amine, to form a salt group. A “pendant group” refers to a group that is an offshoot from the side of the polymer backbone and which is not part of the polymer backbone. In contrast, a “terminal group” refers to a group on an end of the polymer backbone and which is part of the polymer backbone.

Various components can be used to form the polymeric shell. The polymeric shell can, for example, be formed from isocyanate functional polyurethane prepolymers, polyamines, and ethylenically unsaturated monomers. As used herein, a “prepolymer” refers to a polymer precursor capable of further reactions or polymerization by one or more reactive groups to form a higher molecular mass or cross-linked state. The isocyanate functional polyurethane prepolymers can be prepared according to any method known in the art, such as by reacting at least one polyisocyanate with one or more compound(s) having functional groups that are reactive with the isocyanate functionality of the polyisocyanate. Additional reactive functional groups (in addition to the alpha effect based nucleophile functional groups and/or linkages) can be active hydrogen-containing functional groups such as hydroxyl groups, thiol groups, amine groups, hydrazide groups, and acid groups like carboxylic acid groups. A hydroxyl group may react with an isocyanate group to form a urethane linkage. A primary or secondary amine group may react with an isocyanate group to form a urea linkage. Suitable compounds that can be used to form the polyurethane include, but are not limited to, polyols, polyisocyanates, compounds containing carboxylic acids such as diols containing carboxylic acids, polyamines, hydroxyl functional ethylenically unsaturated components such as hydroxyalkyl esters of (meth)acrylic acid, and/or other compounds having reactive functional groups, such as hydroxyl groups, thiol groups, amine groups, hydrazide groups, and carboxylic acids.

Suitable polyisocyanates include isophorone diisocyanate (IPDI), dicyclohexylmethane 4,4′-diisocyanate (H12MDI), cyclohexyl diisocyanate (CHDI), m-tetramethylxylylene diisocyanate (m-TMXDI), p-tetramethylxylylene diisocyanate (p-TMXDI), ethylene diisocyanate, 1,2-diisocyanatopropane, 1,3-diisocyanatopropane, 1,6-diisocyanatohexane (hexamethylene diisocyanate or HDI), 1,4-butylene diisocyanate, lysine diisocyanate, 1,4-methylene bis-(cyclohexyl isocyanate), toluene diisocyanate (TDI), trimethylhexamethylene diisocyanate (TMDI), m-xylylenediisocyanate (MXDI) and p-xylylenediisocyanate, 4-chloro-1,3-phenylene diisocyanate, 1,5-tetrahydro-naphthalene diisocyanate, 4,4′-dibenzyl diisocyanate, and 1,2,4-benzene triisocyanate, xylylene diisocyanate (XDI), and mixtures or combinations thereof.

Suitable polyols that can be used to prepare the polyurethane based polymer include, but are not limited to, lower molecular weight (lower than 2,000 Mn) glycols, polyether polyols, polyester polyols, copolymers thereof, or a combination thereof. Suitable low molecular weight glycols include ethylene glycol, diethylene glycol, triethylene glycol, 1,2-propylene glycol, 1,3-butylene glycol, tetramethylene glycol, hexamethylene glycol, or a combination thereof, as well as other compounds that comprise two or more hydroxyl groups or a combination of any of the foregoing. Suitable polyether polyols include polytetrahydrofuran, polyethylene glycol, polypropylene glycol, polybutylene glycol, or a combination thereof. Suitable polyester polyols include those prepared from a polyol comprising an ether moiety and a carboxylic acid or anhydride.

Number average molecular weight (Mn) and weight average molecular weight (Mw), as reported herein, are measured by gel permeation chromatography using a polystyrene standard according to ASTM D6579-11 performed using a Waters 2695 separation module with a Waters 2414 differential refractometer (RI detector); tetrahydrofuran (THF) was used as the eluent at a flow rate of 1 ml/min, and two PLgel Mixed-C (300×7.5 mm) columns were used for separation at ambient temperature; weight and number average molecular weight of polymeric samples can be measured by gel permeation chromatography relative to linear polystyrene standards of 800 to 900,000 Da.

Other suitable polyols include, but are not limited to, 1,6-hexanediol, cyclohexanedimethanol, 2-ethyl-1,6-hexanediol, 1,4-butanediol, ethylene glycol, propylene glycol, 1,3-propanediol, 1,4-butanediol, neopentyl glycol, trimethylol propane, 1,2,6-hexantriol, glycerol, or a combination thereof. Further, suitable amino alcohols that can be used include, but are not limited to, ethanolamine, propanolamine, butanolamine, or a combination thereof.

Suitable carboxylic acids, which can be reacted with the polyols to form a polyester polyol, include, but are not limited to, glutaric acid, succinic acid, malonic acid, oxalic acid, trimellitic acid, phthalic acid, isophthalic acid, hexahydrophthalic acid, adipic acid, maleic acid, anhydrides thereof, or mixtures thereof. Further, suitable acid containing diols include, but are not limited to, 2,2-bis(hydroxymethyl)propionic acid which is also referred to as dimethylolpropionic acid (DMPA), 2,2-bis(hydroxymethyl)butyric acid which is also referred to as dimethylol butanoic acid (DMBA), diphenolic acid, or a combination thereof. Maleic acid (and/or its anhydride) may be reacted with at least one polyol to form a polyester polyol segment, such that the resulting polyurethane-based polymeric shell comprises an internal maleate functional group thereon, such that the maleate functional group is located on the backbone of the polyurethane shell at a non-terminal location.

Suitable hydroxyalkyl esters of (meth)acrylic acid include hydroxymethyl (meth)acrylate, hydroxyethyl (meth)acrylate, hydroxypropyl (meth)acrylate, hydroxybutyl (meth)acrylate, or a combination thereof.

The components that form the polyurethane prepolymer can be reacted in a stepwise manner, or they can be reacted simultaneously. The polyurethane prepolymer can be formed by reacting a polyisocyanate (e.g., a diisocyanate or a triisocyanate), a polyol, a carboxyl group-containing diol, and a hydroxyl group-containing ethylenically unsaturated monomer. The polyurethane prepolymer can be formed by reacting a polyisocyanate (e.g., a diisocyanate or a triisocyanate), a polyol, a polyfunctional alpha effect based nucleophile containing compound, optionally a hydrazide functional monomer and/or an amine, a carboxyl group-containing diol, and a hydroxyl group-containing ethylenically unsaturated monomer.

After forming the isocyanate functional polyurethane prepolymer, which may be water dispersible, the polyurethane prepolymer may be reacted to form an alpha effect based nucleophile functional polyurethane.

The alpha effect based nucleophile functional polyurethane may comprise a semi-carbazide functional polyurethane. The semi-carbazide functional polyurethane may be prepared by reacting the isocyanate functional polyurethane prepolymer with hydrazine and/or aqueous hydrazine. The isocyanate functional polyurethane may comprise an isothiocyanate functional polyurethane.

The alpha effect based nucleophile functional polyurethane may comprise a carbazate functional polyurethane. The carbazate functional polyurethane may be prepared by reacting a cyclic carbonate functional polyurethane with hydrazine.

The alpha effect based nucleophile functional polyurethane may comprise an oxime functional polyurethane. The oxime functional polyurethane may be prepared by reacting the isocyanate functional polyurethane prepolymer with a hydroxyl-functional oxime compound, such as MEKO. The oxime functional polyurethane may be prepared by condensing a ketone functional polyurethane with hydroxylamine.

The alpha effect based nucleophile functional polyurethane may comprise an aminoxy functional polyurethane. The aminoxy functional polyurethane may be prepared by reacting the isocyanate functional polyurethane prepolymer with a hydroxyl-functional aminoxy compound. The aminoxy functional polyurethane may be prepared by reacting the isocyanate functional polyurethane prepolymer with an oxime (such as a ketoxime and/or aldoxime group) and subsequently deblocking the ketone and/or aldehyde-functional group leaving an aminoxy functional group.

The isocyanate functional polyurethane prepolymer may be reacted with mixtures of the above so as to include some combination of alpha effect based nucleophile functional groups and/or linkages. For example, the isocyanate functional polyurethane prepolymer may be reacted with hydrazine and polycarbonate to form a polyurethane having both semi-carbazide and carbazate functional groups and/or linkages.

The polyurethane prepolymer may additionally be reacted with a polyhydrazide compound to form a water-dispersible polyhydrazide functional polyurethane (the polyhydrazide functionality in addition to the previously-described alpha effect based nucleophile functionality). The polyhydrazide compounds can also chain extend and/or terminally cap the isocyanate functional polyurethane prepolymer and introduce hydrazide functionality thereon. Non-limiting examples of polyhydrazide compounds that can be reacted with the isocyanate functional polyurethane prepolymer include a material or compound having two or more hydrazide functional groups per molecule. The hydrazide component can be chosen from non-polymeric polyhydrazides, polymeric polyhydrazides, or combinations thereof. Non-limiting examples of suitable non-polymeric polyhydrazides include maleic acid dihydrazide, fumaric acid dihydrazide, itaconic acid dihydrazide, phthalic acid dihydrazide, isophthalic acid dihydrazide, terephthalic acid dihydrazide, trimellitic acid trihydrazide, oxalic acid dihydrazide, adipic acid dihydrazide, sebacic acid dihydrazide, and combinations thereof.

The polymeric polyhydrazides can include various types of polymers comprising two or more hydrazide functional groups. For example, the polymeric polyhydrazide can comprise a polyurethane having two or more hydrazide groups. The polyhydrazide functional polyurethane can be prepared by first forming a water-dispersible isocyanate functional polyurethane prepolymer. Such water-dispersible isocyanate functional polyurethane prepolymers can be prepared by reacting polyols, isocyanates, compounds containing carboxylic acids such as diols containing carboxylic acids and, optionally, polyamines. Non-limiting examples of these compounds include any of those previously described.

The polyhydrazide functional core-shell particles that can be used can, for example, be prepared by reacting polyurethane prepolymers having isocyanate and ethylenically unsaturated groups with polyhydrazide compounds to form polyurethanes having hydrazide and ethylenically unsaturated groups. The polyurethanes having hydrazide and ethylenically unsaturated groups are then polymerized in the presence of ethylenically unsaturated monomers and/or polymers to form the core-shell particles. The resulting core-shell particles will comprise a polymeric core prepared from polymerized ethylenically unsaturated monomers and/or polymers (i.e. a core comprising acrylic polymer, a vinyl polymer, or a combination thereof) that is covalently bonded to at least a portion of a polyurethane shell having hydrazide functional groups and urethane linkages. The polymeric shell may also include carboxylic acid functional groups and optionally urea linkages as previously described.

When the polyhydrazide functional core-shell particles are prepared, the resulting mixture may comprise excess residual unreacted hydrazide monomer (e.g., adipic acid dihydrazide). The use of excess hydrazide may result in the polyurethane shell comprising at least one terminal hydrazide functional group. Moreover, some residual unreacted hydrazide monomer may remain in the mixture, which can participate in a curing reaction with formaldehyde.

The polyurethane prepolymers can also be prepared in the presence of catalysts, polymerization inhibitors, or a combination thereof. Suitable catalysts include triethylamine, N-ethyl morpholine, triethyldiamine, and the like, as well as tin type catalysts such as dibutyl tin dilaurate, dioctyl tin dilaurate, and the like. Polymerization inhibitors that can be used to prevent polymerization of the ethylenically unsaturated compounds during formation of the polyurethane include hydroquinone, hydroquinone monomethyl ether, p-benzoquinone, and the like.

The polymeric shell can also optionally be prepared with polyamines and ethylenically unsaturated monomers not incorporated into the polyurethane prepolymer during preparation thereof. The polyamine may be formed as a reaction product of an amine with an ethylenically unsaturated monomer. The isocyanate functional polyurethane prepolymers can be prepared as described above and then reacted with polyamines as chain extenders. As used herein, a “chain extender” refers to a lower molecular weight (Mn less than 2000) compound having two or more functional groups that are reactive towards isocyanate.

Suitable polyamine chain extenders that can be used to prepare the polyurethane based polymer include aliphatic and aromatic compounds, which comprise two or more amine groups selected from primary and secondary amine groups, such as, but not limited to, diamines such as ethylenediamine, hexamethylenediamine, 1,2-propanediamine, 2-methyl-1,5-penta-methylenediamine, 2,2,4-trimethyl-1,6-hexanediamine, isophoronediamine, diaminocyclohexane, xylylenediamine, 1,12-diamino-4,9-dioxadodecane, or a combination thereof. Suitable polyamines are also sold by Huntsman Corporation (The Woodlands, TX) under the trade name JEFFAMINE, such as JEFFAMINE D-230 and JEFFAMINE D-400.

Suitable polyamine functional compounds include the Michael addition reaction products of a polyamine functional compound, such as a diamine. The polyamine functional compound may comprise at least two primary amino groups (i.e., a functional group represented by the structural formula —NH₂). The resulting Michael addition reaction products can include a compound with at least two secondary amino groups (i.e., a functional group represented by the structural formula —NRH in which R is a hydrocarbon). It is appreciated that the secondary amino groups may react with the isocyanate functional groups of the polyurethane prepolymers to form urea linkages and chain extend the polyurethanes.

After reacting the polyurethane prepolymers to form the alpha effected based nucleophile functional polyurethane, optionally with polyamine chain extenders, the polyurethane and additional ethylenically unsaturated monomers can be subjected to a polymerization process to form the core-shell particles. The additional ethylenically unsaturated monomers can be added after forming the polyurethane. Alternatively, the additional ethylenically unsaturated monomers can be used as a diluent during preparation of the polyurethane prepolymer and not added after formation of the polyurethane. It is appreciated that ethylenically unsaturated monomers can be used as a diluent during preparation of the polyurethane prepolymer and also added after formation of the polyurethane.

The additional ethylenically unsaturated monomers can comprise multi-ethylenically unsaturated monomers, mono-ethylenically unsaturated monomers, or a combination thereof. A “mono-ethylenically unsaturated monomer” refers to a monomer comprising only one ethylenically unsaturated group, and a “multi-ethylenically unsaturated monomer” refers to a monomer comprising two or more ethylenically unsaturated groups.

Suitable ethylenically unsaturated monomers include, but are not limited to, alkyl esters of (meth)acrylic acid, hydroxyalkyl esters of (meth)acrylic acid, acid group containing unsaturated monomers, vinyl aromatic monomers, or a combination thereof.

Suitable alkyl esters of (meth)acrylic acid include methyl (meth)acrylate, ethyl (meth)acrylate, butyl (meth)acrylate, isobutyl (meth)acrylate, ethylhexyl (meth)acrylate, lauryl (meth)acrylate, octyl (meth)acrylate, glycidyl (meth)acrylate, isononyl (meth)acrylate, isodecyl (meth)acrylate, vinyl (meth)acrylate, acetoacetoxyethyl (meth)acrylate, acetoacetoxypropyl (meth)acrylate, or a combination thereof. Other suitable alkyl esters include, but are not limited to, di(meth)acrylate alkyl diesters formed from the condensation of two equivalents of (meth)acrylic acid such as ethylene glycol di(meth)acrylate. Di(meth)acrylate alkyl diesters formed from C₂₋₂₄ diols such as butane diol and hexane diol can also be used.

Suitable hydroxyalkyl esters of (meth)acrylic acid include any of those previously described. Suitable acid group containing unsaturated monomers include (meth)acrylic acid, itaconic acid, maleic acid, fumaric acid, crotonic acid, aspartic acid, malic acid, mercaptosuccinic acid, or a combination thereof.

Suitable vinyl aromatic monomers include styrene, 2,4-dimethylstyrene, ethylstyrene, isopropylstyrene, butylstyrene, vinyl naphthalene, vinyl toluene, divinyl aromatic monomers such as divinyl benzene, or a combination thereof.

As previously noted, the ethylenically unsaturated monomers can be polymerized in the presence of the polyurethane, which can also contain ethylenically unsaturated groups, to form the core-shell particles. The polymerization can be conducted using art recognized techniques as well as conventional additives such as emulsifiers, protective colloids, free radical initiators, and chain transfer agents known in the art.

The polymeric shell may be covalently bonded to at least a portion of the polymeric core. For example, the polymeric shell can be covalently bonded to the polymeric core by reacting at least one functional group on the monomers and/or prepolymers that are used to form the polymeric shell with at least one functional group of the monomers and/or prepolymers that are used to form the polymeric core. The functional groups can include any of the functional groups previously described provided that at least one functional group of the monomers and/or prepolymers that are used to form the polymeric shell is reactive with at least one functional group of the monomers and/or prepolymers that are used to form the polymeric core. For instance, the monomers and/or prepolymers that are used to form the polymeric shell and polymeric core can both comprise at least one ethylenically unsaturated group that are reacted with each other to form a chemical bond.

The coating composition may comprise from 1 to 90 weight % of the compound (b1), such as the oligomeric or polymeric compound (b1), based on the total resin solids of the coating composition, such as from 10 to 90 weight %, from 20 to 80 weight %, from 30 to 70 weight %, from 40 to 60 weight %, or from 50 to 60 weight %.

According to Option 1, in addition to the above-described compound (b1), such as the oligomeric or polymeric compound (b1), the coating composition includes (c1) a component reactive with at least one of the alpha effect based nucleophile functional groups and/or linkages, wherein the component comprises (i) formaldehyde, (ii) polyformaldehyde, (iii) a compound that generates formaldehyde, (iv) a polyfunctional ketone, (v) a polyfunctional aldehyde; or a combination thereof. The component (c1) may be reactive in situ in the coating composition with the alpha effect based nucleophile functional groups and/or linkages, such as on the polymeric shell of the (b1) oligomeric or polymeric compound.

The (c1) component reactive with at least one of the alpha effect based nucleophile functional groups and/or linkages may comprise an acid functional group (instead of or in addition to the (b1) oligomeric or polymeric compound comprising an acid functional group). The acid functional group may render (b1) and/or (c1) water dispersible.

The compound that generates formaldehyde may refer to a compound that does not comprise formaldehyde under first conditions, but when exposed to second conditions different from the first conditions, generates formaldehyde, which formaldehyde may react with other components of the coating composition (e.g., the alpha effect based nucleophile groups and/or linkages of the oligomeric or polymeric compound). The conditions that may cause generation of the formaldehyde include the inclusion of an acid catalyst, the passage of a time at an ambient temperature, or an expedited generation at an elevated temperature of at least 70° C. For example, the compound that generates formaldehyde may include a melamine formaldehyde resin. As used herein, a “melamine formaldehyde resin” refers to a resin with at least one melamine ring terminated with multiple hydroxyl groups derived from formaldehyde. The melamine formaldehyde resin may generate formaldehyde in the presence of heat and/or a catalyst. The melamine formaldehyde resin may contain and/or generate formaldehyde in an amount of 0.1 to 3 weight %, based on total resin solids of the coating composition. The coating composition may comprise from 0 to 50 weight %, such as from 5 to 50 weight % or from 10 to 30 weight % of the melamine formaldehyde resin, based on the total resin solids of the coating composition. The coating composition may comprise up to 50 weight %, such as up to 40 weight % or up to 30 weight % of the melamine formaldehyde resin, based on the total resin solids of the coating composition. The coating composition may comprise at least 5 weight %, such as at least 10 weight % of the melamine formaldehyde resin, based on the total resin solids of the coating composition.

The total amount of formaldehyde present and/or generated in (c1) in the coating composition may range from 0.1 to 3 weight %, based on the total resin solids of the coating composition. The formaldehyde may react with the alpha effect based nucleophile functional groups and/or linkages.

The polyfunctional ketone may comprise any suitable compound comprising at least two ketone functional groups. The polyfunctional aldehyde may comprise at least two functional aldehyde groups or their hydrates, or their acetals or hemiacetals.

For example, the polyfunctional ketone and/or polyfunctional aldehyde may comprise the Michael addition reaction products of a polyamine functional compound, such as a diamine, with keto and/or aldo containing ethylenically unsaturated monomers. The polyamine functional compound typically comprises at least two primary amino groups (i.e., a functional group represented by the structural formula —NH₂), and the keto and/or aldo containing unsaturated monomers include, but are not limited to, (meth)acrolein, diacetone (meth)acrylamide, diacetone (meth)acrylate, acetoacetoxyethyl (meth)acrylate, vinyl acetoacetate, crotonaldehyde, 4-vinylbenzaldehyde, and combinations thereof. The resulting Michael addition reaction products can include a compound with at least two secondary amino groups (i.e., a functional group represented by the structural formula —NRH in which R is a hydrocarbon) and at least two keto and/or aldo functional groups. It is appreciated that the secondary amino groups will react with the isocyanate functional groups of the polyurethane prepolymers to form urea linkages and chain extend the polyurethanes. Further, the keto and/or aldo functional groups will extend out from the backbone of the chain-extended polyurethane, such as from the nitrogen atom of the urea linkage, for example, to form a polyurethane with pendant keto and/or aldo functional groups.

The polyfunctional ketone may be contained as part of an acrylic polymer using (meth)acrylate monomers comprising ketone functionality, such as diacetone acrylamide (DAAM). The polyfunctional ketone may comprise a polyester, or polyester-polyurethane, or epoxy derived from compounds, such as levulinic acid. The polyfunctional ketone may comprise the reaction product of a polyepoxide and levulinic acid (or other monomer comprising ketone functionality and at least one other non-keto functional group, where the at least one other non-keto functional group reacts with another species to form a new compound having ketone functionality). The reaction of polyepoxide and levulinic acid may form a polyol comprising keto functionality which can participate in a subsequent reaction to form a polyurethane and/or a polyester having keto functionality. The polyepoxide may comprise glycidyl methacrylate (GMA), such as a polyfunctional acrylic comprising GMA. The polyfunctional ketone may comprise the reaction product of levulinic acid esterified with a tetraol or higher functional polyol, such as pentaerythritol and/or di(trimethylol propane).

The polyfunctional aldehyde may comprise a reaction product of glyoxylic acid with polyepoxides or polyols to generate polyfunctional aldehydes.

The coating composition may comprise from 3 to 90 weight % of the polyfunctional ketone and/or polyfunctional aldehyde, based on the total resin solids of the coating composition, such as from 3 to 20 weight %, from 5 to 20 weight %, from 10 to 20 weight %, from 20 to 70 weight %, from 30 to 60 weight %, or from 40 to 50 weight %. The polyfunctional ketone and/or polyfunctional aldehyde may react with the alpha effect based nucleophile functional groups.

According to Option 2, the coating composition includes compound (b2), such as an oligomeric or polymeric compound (b2) comprising a plurality of n-methylolated alpha effect based nucleophile functional groups and/or linkages.

The compound (b2), such as the oligomeric or polymeric compound (b2) may be made in a similar way and have similar properties compared to the compound (b1), such as the oligomeric or polymeric compound (b1) (as described above) except that the compound (b1), such as the oligomeric or polymeric compound (b1) (the alpha effect based nucleophile functional groups and/or linkage thereof) are pre-reacted (prior to inclusion in the final coating composition) with formaldehyde and/or polyformaldehyde and/or formaldehyde from the compound that generates formaldehyde to form the two or more N-methylolated alpha effect based nucleophile functional groups and/or linkages in the compound (b2), such as the oligomeric or polymeric compound (b2).

The compound (b1), such as the oligomeric or polymeric compound (b1) may be mixed with (c1) and aged for a time period to form the N-methylolated alpha effect based nucleophile functional groups and/or linkages in the compound (b2), such as the oligomeric or polymeric compound (b2) before inclusion in the coating composition. The mixture may be aged for any suitable time period, such as 24 hours. The mixture may be aged at elevated temperatures (relative to ambient temperature, such as from 40° C. to 60° C.

The compound (b2), such as the oligomeric or polymeric compound (b2), may comprise any of the above-described n-methylolated alpha effect based nucleophile functional groups and/or linkages. The compound (b2), such as the oligomeric or polymeric compound (b2) may comprise an n-methylolated semi-carbazide functional group and/or linkage, an n-methylolated carbazate functional group and/or linkage, an n-methylolated oxime functional group, an n-methylolated aminoxy functional group and/or linkage, or combinations thereof. The plurality of n-methylolated alpha effect based nucleophile functional groups and/or linkages may comprise at least two of the same n-methylolated alpha effect based nucleophile functional groups and/or linkages. The plurality of n-methylolated alpha effect based nucleophile functional groups and/or linkages may comprise at least two different n-methylolated alpha effect based nucleophile functional groups and/or linkages. For example, the compound (b2), such as the oligomeric or polymeric compound (b2), may comprise both an n-methylolated carbazate and an n-methylolated semi-carbazide alpha effect based nucleophile functional group and/or linkage. The compound (b2), such as the oligomeric or polymeric compound (b2), may comprise both an n-methylolated carbazate alpha effect based nucleophile functional group and/or linkage and an n-methylolated oxime alpha effect based nucleophile functional group. The compound (b2), such as the oligomeric or polymeric compound (b2), may comprise both an n-methylolated carbazate and an n-methylolated aminoxy alpha effect based nucleophile functional group and/or linkage. The compound (b2), such as the oligomeric or polymeric compound (b2), may comprise both an n-methylolated semi-carbazide alpha effect based nucleophile functional group and/or linkage and an n-methylolated oxime alpha effect based nucleophile functional group. The compound (b2), such as the oligomeric or polymeric compound (b2), may comprise both an n-methylolated semi-carbazide and an n-methylolated aminoxy alpha effect based nucleophile functional group and/or linkage. The compound (b2), such as the oligomeric or polymeric compound (b2), may comprise both an n-methylolated aminoxy alpha effect based nucleophile functional group and/or linkage and an n-methylolated oxime alpha effect based nucleophile functional group. The compound (b2), such as the oligomeric or polymeric compound (b2), may comprise both an n-methylolated aminoxy alpha effect based nucleophile functional group and/or linkage and an n-methylolated oxime alpha effect based nucleophile functional group. The compound (b2), such as the oligomeric or polymeric compound (b2), may comprise an n-methylolated semi-carbazide and an n-methylolated carbazate alpha effect based nucleophile functional group and/or linkage and an n-methylolated oxime alpha effect based nucleophile functional group. The compound (b2), such as the oligomeric or polymeric compound (b2), may comprise an n-methylolated semi-carbazide and an n-methylolated aminoxy alpha effect based nucleophile functional group and/or linkage and an n-methylolated oxime alpha effect based nucleophile functional group. The compound (b2), such as the oligomeric or polymeric compound (b2), may comprise an n-methylolated aminoxy and an n-methylolated carbazate alpha effect based nucleophile functional group and/or linkage and an n-methylolated oxime alpha effect based nucleophile functional group. The compound (b2), such as the oligomeric or polymeric compound (b2), may comprise an n-methylolated semi-carbazide, an n-methylolated carbazate, and an n-methylolated aminoxy alpha effect based nucleophile functional group and/or linkage. The compound (b2), such as the oligomeric or polymeric compound (b2), may comprise an n-methylolated semi-carbazide, an n-methylolated carbazate, and an n-methylolated aminoxy alpha effect based nucleophile functional group and/or linkage and an n-methylolated oxime alpha effect based nucleophile functional group.

The (c1) may be added in amount such that not all alpha effect based nucleophile functional groups and/or linkages are reacted therewith (e.g., by a stoichiometric excess of alpha effect based nucleophile functional groups and/or linkages). The (c1) may be added in amount such that substantially all (>95%) or all alpha effect based nucleophile functional groups and/or linkages are reacted therewith (e.g., by including a stoichiometric excess of the reactive functional group of (c1)). The stoichiometric ratio of reactive functional groups (reactive with the alpha effect based nucleophile functional groups and/or linkages) of (c1) to alpha effect based nucleophile functional groups and/or linkages may be 1:1 or may range from 3:1 to 1:3, such as from 2:1 to 1:2 or from 1.5:1 to 1:1.5.

The coating composition may comprise from 1 to 90 weight % of the compound (b2), such as the oligomeric or polymeric compound (b2) based on the total resin solids of the coating composition, such as from 10 to 90 weight %, from 20 to 80 weight %, from 30 to 70 weight %, from 40 to 60 weight %, or from 50 to 60 weight %.

The coating composition may be prepared according to both Option 1 and Option 2 so as to include a compound (b1), such as an oligomeric or polymeric compound (b1), comprising a plurality of alpha effect based nucleophile functional groups and/or linkages and (c1) a component reactive with at least one of the alpha effect based nucleophile functional groups and/or linkages and a compound (b2), such as an oligomeric or polymeric compound (b2), comprising a plurality of n-methylolated alpha effect based nucleophile functional groups and/or linkages.

The compound (b1) and/or (b2), such as the oligomeric or polymeric compound (b1) and/or (b2) may comprise a polyurethane polymer, an acrylic polymer, a polyester polymer, or some combination thereof. For example, the compound (b1) and/or (b2), such as the oligomeric or polymeric compound (b1) and/or (b2), may comprise polyurethane-acrylate core-shell particles including a polymeric acrylic core having a polymeric polyurethane shell.

The compound (b1) and/or (b2), such as the oligomeric or polymeric compound (b1) and/or (b2), may comprise aliphatic and/or aromatic rings.

The compound (b1) and/or (b2), such as the oligomeric or polymeric compound (b1) and/or (b2), may comprise a polyurethane polymer, an acrylic polymer, a polyester polymer, or a combination thereof. For example, the compound (b1) and/or (b2), such as the oligomeric or polymeric compound (b1) and/or (b2), may comprise polyurethane-acrylate core-shell particles including a polyurethane shell and an acrylic core. The shell and/or the core may comprise a polyurethane polymer. The shell and/or the core may comprise an acrylic polymer. The shell and/or the core may comprise a polyester polymer.

The coating composition may further comprise a polyester polymer. The polyester polymer may be obtained from components comprising polytetrahydrofuran and a carboxylic acid or anhydride thereof. The polyester polymer may comprise a hydroxyl functional group.

The carboxylic acid or anhydride used to form the polyester polymer can be selected from various types of polycarboxylic acids or the anhydrides thereof, such as from a dicarboxylic acid or anhydride thereof, or from a polycarboxylic acid having three or more carboxylic acid groups or the anhydrides thereof. The carboxylic acid or anhydride thereof can also be selected from compounds having aromatic rings or aliphatic structures. As used herein, an “aromatic group” refers to a cyclically conjugated hydrocarbon with a stability (due to delocalization) that is significantly greater than that of a hypothetical localized structure. Further, the term “aliphatic” refers to non-aromatic straight, branched, or cyclic hydrocarbon structures that contain saturated carbon bonds.

Non-limiting examples of carboxylic acids used to form the polyester polymer include any of those previously listed. As indicated, an anhydride can be used, such as an anhydride of any of the previously described carboxylic acids. The carboxylic acid or anhydride may comprise trimellitic acid and/or anhydride. Non-limiting examples of such anhydrides include trimellitic anhydride, phthalic anhydride, maleic anhydride, succinic anhydride, malonic anhydride, oxalic anhydride, hexahydrophthalic anhydride, adipic anhydride, and combinations thereof.

As indicated, the carboxylic acid or anhydride thereof can be selected from compounds having aromatic rings or aliphatic structures. For instance, the carboxylic acid or anhydride thereof can be selected from an aromatic compound in which the carboxylic acid or anhydride functional groups are bonded directly to the aromatic ring(s) such that there is no interrupting atoms between the aromatic ring(s) and the attached carboxylic acid or anhydride functional groups (a non-limiting example being trimellitic anhydride).

The polyester polymer can also be prepared with other components in addition to the previously described polytetrahydrofuran and carboxylic acid or anhydride thereof. Non-limiting examples of additional components that can be used to form the polyester polymer include polyols in addition to the polytetrahydrofuran, additional compounds containing one or more carboxylic acid groups or anhydrides thereof, ethylenically unsaturated compounds, polyisocyanates, and combinations thereof.

Non-limiting examples of polyols used to form the polyester polymer include glycols, polyether polyols, polyester polyols, copolymers thereof, and combinations thereof. Non-limiting examples of glycols include ethylene glycol, diethylene glycol, triethylene glycol, 1,2-propylene glycol, 1,3-butylene glycol, tetramethylene glycol, hexamethylene glycol, and combinations thereof, as well as other compounds that comprise two or more hydroxyl groups and combinations of any of the foregoing. Non-limiting examples of suitable polyether polyols in addition to the polytetrahydrofuran include polyethylene glycol, polypropylene glycol, polybutylene glycol, and combinations thereof.

Other suitable polyols used to form the polyester polymer include any of those previously listed. It is appreciated that the polyol can be selected from diols and/or from compounds having 3 or more hydroxyl groups.

The additional compounds containing one or more carboxylic acid groups or anhydrides can be used to form the polyester polymer include any of the previously described carboxylic acids and anhydrides provided that the additional compound is different from the first carboxylic acid or anhydride. For instance, the components that form the polyester polymer can include both trimellitic anhydride and maleic anhydride.

Non-limiting examples of ethylenically unsaturated monomers, including those containing an acid group, used to form the polyester polymer include any of those previously listed. Non-limiting examples of vinyl aromatic monomers used to form the polyester polymer include any of those previously listed. Non-limiting examples of suitable polyisocyanates used to form the polyester polymer include any of those previously listed.

It is appreciated that the previously described optional additional components can be used to modify or adjust the properties of the polyester polymer and the final coating formed therewith. For instance, the polyester polymer can be formed with additional components, such as an additional polyol, that can provide a faster cure at lower bake temperatures such as temperatures of 80° C. or lower.

The polytetrahydrofuran used to form the polyester polymer can comprise at least 20 weight % of the components that form the polyester polymer, or at least 30 weight % of the components that form the polyester polymer, or at least 40 weight % of the components that form the polyester polymer. The polytetrahydrofuran can also comprise up to 50 weight % of the components that form the polyester polymer, or up to 60 weight % of the components that form the polyester polymer, or up to 70 weight % of the components that form the polyester polymer, or up to 80 weight % of the components that form the polyester polymer, or up to 90 weight % of the components that form the polyester polymer. The polytetrahydrofuran can further comprise an amount within a range such as from 20 weight % to 90 weight % of the components that form the polyester polymer, or from 40 weight % to 80 weight % of the components that form the polyester polymer, or from 50 weight % to 70 weight % of the components that form the polyester polymer, or from 30 weight % to 40 weight % of the components that form the polyester polymer.

The carboxylic acid or anhydride used to form the polyester polymer can comprise at least 5 weight % of the components that form the polyester polymer, or at least 8 weight % of the components that form the polyester polymer. The carboxylic acid or anhydride can also comprise up to 20 weight % of the components that form the polyester polymer, or up to 15 weight % of the components that form the polyester polymer, or up to 12 weight % of the components that form the polyester polymer. The carboxylic acid or anhydride can further comprise a range of from 5 weight % to 20 weight % of the components that form the polyester polymer, or from 8 weight % to 15 weight % of the components that form the polyester polymer, or from 8 weight % to 12 weight % of the components that form the polyester polymer, or from 7 weight % to 10 weight % of the components that form the polyester polymer.

It is appreciated that one or more of the previously described additional components can make up the remaining amount of components used to form the polyester polymer. For example, the polyester polymer can be prepared with polytetrahydrofuran, a carboxylic acid or anhydride, a polyol that is different from the polytetrahydrofuran, and another carboxylic acid or anhydride that is different from the first carboxylic acid or anhydride.

The resulting polyester polymer prepared from the previously described components may comprise ether linkages and/or carboxylic acid functional groups. The polyester polymer can also comprise urethane linkages as well as additional functional groups such as hydroxyl functional groups. For instance, the polyester polymer can comprise ether linkages, ester linkages, carboxylic acid functional groups, and hydroxyl functional groups. The polyester polymer can also comprise additional linkages and functional groups including, but not limited to, the previously described additional functional groups.

The polyester polymer can have an acid value of at least 15, at least 20, at least 30, at least 35, or at least 40, based on the total resin solids of the polyester polymer. The polyester polymer can have an acid value of up to 60, up to 55, up to 50, up to 45, up to 40, up to 35, or up to 30, based on the total resin solids of the polyester polymer. The polyester polymer can have an acid value ranging from 15 to 60, such as from 20 to 30, from 20 to 50, from 20 to 60, from 30 to 50, from 30 to 60, from 35 to 60, from 35 to 50, from 40 to 50, or from 40 to 60, based on the total resin solids of the polyester polymer. Any acid value or hydroxyl value recited herein is determined using a Metrohm 798 MPT Titrino automatic titrator, manufactured by Metrohm AG (Herisau, Switzerland), according to ASTM D 4662-15 and ASTM E 1899-16, respectively.

The acid functionality of the polyester polymer can have a pKa of less than 5, or less than 4.5, or less than 4, or less than 3.5, or less than 3, or less than 2.5, or less than 2. The acid functionality of the polyester polymer can be within a pKa range such as for example from 1.5 to 4.5. The pKa value is the negative (decadic) logarithms of the acidic dissociation constant, and is determined according to the titration method described in Lange's Handbook of Chemistry, 15th edition, section 8.2.1.

The carboxylic acid functionality found on the polyester polymer can be provided by the first carboxylic acid or anhydride only. Alternatively, when additional carboxylic acid functional compounds and/or anhydrides are used to form the polymer, the carboxylic acid functionality found on the polymer is provided by the first carboxylic acid or anhydride and the additional carboxylic acid functional compounds and/or anhydrides.

The polyester polymer can also comprise a hydroxyl equivalent weight of from 1500 to 5000, or from 2000 to 3000, as measured by reacting the dried polyester polymer with an excess amount of acetic anhydride and titrating with potassium hydroxide.

The coating composition may include from 5 to 50 weight % of the polyester polymer based on total resin solids of the coating composition, such as from 5 to 40 weight %, from 5 to 30 weight %, from 5 to 20 weight %, from 10 to 40 weight %, from 10 to 30 weight %, or from 10 to 20 weight %.

The coating composition may further comprise a polymer reactive with at least one of (b1), (b2), or (c1). The polymer may be obtained from components comprising N-(hydroxymethyl)acrylamide, N-(isobutoxymethyl)acrylamide, or a combination thereof.

In addition, the coating composition can comprise additional materials including, but not limited to, optional additional resins such as additional film-forming resins.

The additional resin can include any of a variety of thermoplastic and/or thermosetting film-forming resins known in the art. The term “thermosetting” refers to resins that “set” irreversibly upon curing or crosslinking, wherein the polymer chains of the resins are joined together by covalent bonds. Once cured or crosslinked, a thermosetting resin will not melt upon the application of heat and is insoluble in solvents. As noted, the film-forming resin can also include a thermoplastic film-forming resin. The term “thermoplastic” refers to resins wherein the polymer chains are not joined together by covalent bonds and, thereby, can undergo liquid flow upon heating and can be soluble in certain solvents.

Suitable additional resins include polyurethanes other than those previously described, polyesters (e.g., polyester polyols), polyamides, polyethers, polysiloxanes, fluoropolymers, polysulfides, polythioethers, polyureas, (meth)acrylic resins (e.g., acrylic dispersions), epoxy resins, vinyl resins, copolymers thereof, or mixtures thereof. The additional resin may include a core-shell particle different from those previously described. The additional resin may include a non-core-shell particle resin. The additional resin may include a grind resin used to introduce pigment into the coating composition.

The additional resin can have any of a variety of reactive functional groups including, but not limited to, carboxylic acid groups, amine groups, epoxide groups, hydroxyl groups, thiol groups, carbamate groups, amide groups, urea groups, isocyanate groups (including blocked isocyanate groups), (meth)acrylate groups, and combinations thereof. Thermosetting coating compositions typically comprise a crosslinker that may be selected from any of the crosslinkers known in the art to react with the functionality of the resins used in the coating compositions. Alternatively, a thermosetting film-forming resin can be used having functional groups that are reactive with themselves; in this manner, such thermosetting resins are self-crosslinking.

The coating composition may include the optional additional resin. When the optional additional resin is included in the coating composition, the coating composition may include from 5 to 40 weight % of the additional resin based on the total resin solids, such as from 5 to 30 weight %, from 5 to 20 weight %, from 10 to 40 weight %, from 10 to 30 weight %, from 20 to 30 weight %, or from 15 to 30 weight %. The coating composition may include up to 40 weight % of the additional resin based on total resin solids, such as up to 30 weight %, up to 20 weight %, or up to 10 weight %.

The coating composition may comprise an acid catalyst. The acid catalyst may be a separate component from the oligomeric or polymeric compound (b1) and/or (b2), such as a phosphoric or phosphonic or sulfonic acid catalyst. Non-limiting examples include phenyl phosphonic acid, 2-ethylhexyl acid phosphate, dodecyl benzene sulfonic acid, para-toluene sulfonic acid, or a combination thereof. The separate acid catalyst component may comprise a separate polymer (different from the oligomeric or polymeric compound (b1) and/or (b2)) comprising the acid catalyst, such as an acrylic polymer comprising an acid catalyst or an epoxy resin comprising an acid catalyst (e.g., a phosphatized acrylic or phosphatized epoxy resin). The acid catalyst, such as carboxylic acid, may be bonded to compound (b1) and/or (b2), such as to oligomeric or polymeric compound (b1) and/or (b2). For example, the compound (b1) and/or (b2), such as the oligomeric or polymeric compound (b1) and/or (b2), may comprise a phosphonic and/or sulfonic acid acrylate, such as a phosphonic and/or sulfonic acid acrylate of the above-described core-shell particles.

The acid catalyst may comprise carboxylic acid functional groups formed on the compound (b1) and/or (b2), such as the oligomeric or polymeric compound (b1) and/or (b2). The carboxylic acid functional groups may be obtained from a carboxylic acid or anhydride thereof having a pKa of less than 5.5, such as dimethylolpropionic acid (DMPA). The carboxylic acid functional groups may be obtained from a carboxylic acid or anhydride thereof having a pKa of less than 3, such as trimellitic anhydride.

The coating composition may be substantially free (less than 5 weight % based on the total resin solids) of unreacted polyisocyanate. The coating composition may be essentially free (less than 1 weight % based on the total resin solids) of unreacted polyisocyanate. The coating composition may be free (0 weight % based on the total resin solids) of unreacted polyisocyanate. As used herein, “unreacted isocyanate” refers to a molecule having at least one —N═C═O group at ambient temperature.

The coating composition may be substantially free (less than 5 weight % based on total resin solids) of polyurethane-acrylate core-shell particles containing keto and/or aldo functional groups or other additional latex resins containing keto and/or aldo functional groups. The coating composition may be essentially free (less than 1 weight % based on total resin solids) of polyurethane-acrylate core-shell particles containing keto and/or aldo functional groups or other additional latex resins containing keto and/or aldo functional groups. The coating composition may be free (0 weight % based on total resin solids) of polyurethane-acrylate core-shell particles containing keto and/or aldo functional groups or other additional latex resins containing keto and/or aldo functional groups.

The coating composition may include an adhesion promoter. The adhesion promotor may comprise a silane compound. The adhesion promotor may be reactive with the substrate to which the coating composition is applied and the resin of the coating composition so as to enhance adhesion of the cured coating to the substrate.

The coating composition may further comprise a crosslinker reactive with functional groups and/or linkages on at least one of: (i) the compound (b1) and/or (b2), such as the oligomeric or polymeric compound (b1) and/or (b2); (ii) the compound (c1); or (iii) a reaction product obtained from the compound (b1), such as the oligomeric or polymeric compound (b1) and the compound (c1). The crosslinker may comprise a blocked isocyanate, a carbodiimide, an aminoplast, or a combination thereof. The aminoplast crosslinker may include melamine. The aminoplast crosslinker may include condensates of amines and/or amides with aldehyde. For example, the condensate of melamine with formaldehyde is an example of a suitable aminoplast. The aminoplast crosslinker may be separate from (c1)(iii) the compound that generates formaldehyde (e.g., the melamine formaldehyde resin). The crosslinker may be separate from (b1) and/or (b2), and (c1).

The coating composition may be a one-component (1K) curing composition. As used herein, a “1K curing composition” refers to a composition wherein all the coating components are maintained in the same container after manufacture, during storage, and the like, and may remain stable for longer than 1 month at conditions of 40-120° F. (4-49° C.) at 0-95% relative humidity, such as longer than 3 months, longer than 6 months, longer than 9 months, or longer than 12 months. A 1K curing composition can be applied to a substrate and cured by any conventional means, such as by heating, forced air, and the like.

The coating composition can also include additional materials such as a pigment. The pigment may include a finely divided solid powder that is insoluble, but wettable, under the conditions of use. A pigment can be organic or inorganic and can be agglomerated or non-agglomerated. Pigments can be incorporated into the coating by use of a grind vehicle, such as an acrylic grind vehicle, the use of which will be familiar to one skilled in the art. The core-shell particles (b1) and/or (b2) may function as the grind vehicle for the pigment.

Suitable pigments and/or pigment compositions include, but are not limited to, carbazole dioxazine crude pigment, azo, monoazo, diazo, naphthol AS, salt type (flakes), benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, or mixtures thereof.

The pigment used with the coating composition can also comprise a special effect pigment. As used herein, a “special effect pigment” refers to a pigment that interacts with visible light to provide an appearance effect other than, or in addition to, a continuous unchanging color. Suitable special effect pigments include those that produce one or more appearance effects such as reflectance, pearlescence, metallic sheen, texture, phosphorescence, fluorescence, photochromism, photosensitivity, thermochromism, goniochromism, and/or color-change, such as transparent coated mica and/or synthetic mica, coated silica, coated alumina, aluminum flakes, a transparent liquid crystal pigment, a liquid crystal coating, or a combination thereof.

In some examples, the coating composition may be a clearcoat substantially free of a pigment. Substantially free of a pigment may mean that the coating composition comprises less than 3 weight % of pigment, based on the total solids, such as less than 2 weight %, less than 1 weight %, or 0 weight %.

Other suitable materials that can be used with the coating composition include, but are not limited to, plasticizers, abrasion resistant particles, anti-oxidants, hindered amine light stabilizers, UV light absorbers and stabilizers, surfactants, flow and surface control agents, thixotropic agents, catalysts, reaction inhibitors, and other customary auxiliaries.

The coating composition may be curable at a temperature of less than or equal to 100° C. According to the invention, when the coating composition is applied to a substrate to form a layer having a thickness from 5 to 100 microns and baked at 100° C. for 30 minutes, the layer may achieve at least 35, such as at least 50, at least 70, at least 90, or at least 100 MEK double rubs as measured according to the Solvent Resistance Test described herein. The coating composition may be curable at a temperature of less than or equal to 80° C. According to the present invention, when the coating composition is applied to a substrate to form a layer having a thickness from 5 to 100 microns and baked at 80° C. for 30 minutes, the layer may achieve at least 35, such as at least 50, at least 70, at least 90, or at least 100 MEK double rubs as measured according to the Solvent Resistance Test described herein.

The coating composition may be applied to a substrate and cured to form a coating thereover. The coating may be a continuous film formed over at least a portion the substrate.

The substrate over which the coating composition may be applied includes a wide range of substrates. For example, the coating composition of the present invention can be applied to a vehicle substrate, an industrial substrate, an aerospace substrate, and the like.

The vehicle substrate may include a component of a vehicle. In the present disclosure, the term “vehicle” is used in its broadest sense and includes all types of aircraft, spacecraft, watercraft, and ground vehicles. For example, the vehicle can include, but is not limited to an aerospace substrate (a component of an aerospace vehicle, such as an aircraft such as, for example, airplanes (e.g., private airplanes, and small, medium, or large commercial passenger, freight, and military airplanes), helicopters (e.g., private, commercial, and military helicopters), aerospace vehicles (e.g., rockets and other spacecraft), and the like). The vehicle can also include a ground vehicle such as, for example, animal trailers (e.g., horse trailers), all-terrain vehicles (ATVs), cars, trucks, buses, vans, heavy duty equipment, tractors, golf carts, motorcycles, bicycles, snowmobiles, trains, railroad cars, and the like. The vehicle can also include watercraft such as, for example, ships, boats, hovercrafts, and the like. The vehicle substrate may include a component of the body of the vehicle, such as an automotive hood, door, trunk, roof, and the like; such as an aircraft or spacecraft wing, fuselage, and the like; such as a watercraft hull, and the like.

The coating composition may be applied over an industrial substrate which may include tools, heavy duty equipment, furniture such as office furniture (e.g., office chairs, desks, filing cabinets, and the like), appliances such as refrigerators, ovens and ranges, dishwashers, microwaves, washing machines, dryers, small appliances (e.g., coffee makers, slow cookers, pressure cookers, blenders, etc.), metallic hardware, extruded metal such as extruded aluminum used in window framing, other indoor and outdoor metallic building materials, and the like.

The coating composition may be applied over storage tanks, windmills, nuclear plant components, packaging substrates, wood flooring and furniture, apparel, electronics, including housings and circuit boards, glass and transparencies, sports equipment, including golf balls, stadiums, buildings, bridges, and the like.

The substrate can be metallic or non-metallic. Metallic substrates include, but are not limited to, tin, steel (including electrogalvanized steel, cold rolled steel, hot-dipped galvanized steel, among others), aluminum, aluminum alloys, zinc-aluminum alloys, steel coated with a zinc-aluminum alloy, and aluminum plated steel. Non-metallic substrates include polymeric materials, plastic and/or composite material, polyester, polyolefin, polyamide, cellulosic, polystyrene, polyacrylic, poly(ethylene naphthalate), polypropylene, polyethylene, nylon, ethylene vinyl alcohol (EVOH), polylactic acid, other “green” polymeric substrates, poly(ethyleneterephthalate) (PET), polycarbonate, polycarbonate acrylobutadiene styrene (PC/ABS), wood, veneer, wood composite, particle board, medium density fiberboard, cement, stone, glass, paper, cardboard, textiles, leather, both synthetic and natural, and the like. The substrate may comprise a metal, and/or a plastic and/or composite material, and/or a fibrous material. The fibrous material may comprise a nylon and/or a thermoplastic polyolefin material with continuous strands or chopped carbon fiber. The substrate can be one that has already been treated in some manner, such as to impart visual and/or color effect, a protective pretreatment or other coating layer, and the like.

The coating composition of the present invention may be particularly beneficial when applied to a metallic substrate. The coatings of the present invention may be particularly beneficial when applied to metallic substrates that are used to fabricate automotive vehicles, such as cars, trucks, and tractors.

The coating composition may be applied to a substrate having multiple components, wherein the coating composition is simultaneously applied to the multiple components and simultaneously cured to form a coating over the multiple components without deforming, distorting, or otherwise degrading any of the components. The components may be parts of a larger whole of the substrate. The components may be separately formed and subsequently arranged together to form the substrate. The components may be integrally formed to form the substrate.

Non-limiting examples of components of a substrate in the vehicle context include a vehicle body (e.g., made of metal) and a vehicle bumper (e.g., made or plastic) which are separately formed and subsequently arranged to form the substrate of the vehicle. Further examples include a plastic automotive component, such as a bumper or fascia in which the bumper or fascia comprises regions or subcomponents which comprise more than one type of substrate. Further examples include aerospace or industrial components comprising more than one substrate type. It will be appreciated that other such other multi-component substrates are contemplated within the context of this disclosure.

The multiple components may include at least a first component and a second component, and the first component and the second component may be formed from different materials. As used herein, “different materials” refers to the materials used to form the first and second component having different chemical make-ups.

The different materials may be from the same or different class of materials. As used herein, a “class of materials” refers to materials that may have a different specific chemical make-up but share the same or similar physical or chemical properties. For example, metals, polymers, ceramics, and composites may be defined as different classes of materials. However, other classes of materials may be defined depending on similarities in physical or chemical properties, such as nanomaterials, biomaterials, semiconductors, and the like. Classes of materials may include crystalline, semi-crystalline, and amorphous materials. Classes of materials, such as for polymers, may include thermosets, thermoplastics, elastomers, and the like. Classes of materials, such as for metals, may include alloys and non-alloys. As will be appreciated from the above exemplary list of classes, other relevant classes of materials may be defined based on a given physical or chemical property of materials.

The first component may be formed from a metal, and the second component may be formed from a plastic or a composite. The first component may be formed from a plastic, and the second component may be formed from a metal or a composite. The first component may be formed from a composite, and the second component may be formed from a plastic or a metal. The first component may be formed from a first metal, and the second component may be formed from a second metal different from the first metal. The first component may be formed from a first plastic, and the second component may be formed from a second plastic different from the first plastic. The first component may be formed from a first composite, and the second component may be formed from a second composite different from the first composite. As will be appreciated from these non-limiting examples, any combination of different materials from the same or different classes may form the first and second components.

Examples of combinations of materials include thermoplastic polyolefins (TPO) and metal, TPO and acrylonitrile butadiene styrene (ABS), TPO and acrylonitrile butadiene styrene/polycarbonate blend (ABS/PC), polypropylene and TPO, TPO and a fiber reinforced composite, and other combinations. Further examples include aerospace substrates or industrial substrates comprising various components made of a plurality of materials, such as various metal-plastic, metal-composite, and/or plastic-composite containing components. The metals may include ferrous metals and/or non-ferrous metals. Non-limiting examples of non-ferrous metals include aluminum, copper, magnesium, zinc, and the like, and alloys including at least one of these metals. Non-limiting examples of ferrous metals include iron, steel, and alloys thereof.

The first component and the second component (the materials thereof) may exhibit different physical or chemical properties when exposed to elevated temperatures. For example, the first component may deform, distort, or otherwise degrade at a temperature lower than the second component. Non-limiting examples of material properties which may indicate whether a first component deforms, distorts, or otherwise degrades at a temperature lower than the second component include: heat deflection temperature, embrittlement temperature, softening point, and other relevant material properties associated with deformation, distortion, or degradation of materials.

For example, the first component may deform, distort, or otherwise degrade at temperatures ranging from above 80° C. to 120° C., whereas the second component may not deform, distort, or otherwise degrade at temperatures within or below this range. The first component may deform, distort, or otherwise degrade at temperatures below 120° C., such as below 110° C., below 100° C., or below 90° C., whereas the second component may not deform, distort, or otherwise degrade at temperatures within these ranges.

When the coating composition of the present invention is applied to the substrate having multiple components simultaneously, the applied coating composition may be cured at a temperature which does not deform, distort, or otherwise degrade either of the first and second component (the materials thereof). Thus, the curing temperature may be below the temperature at which either of the first component or the second component would deform, distort, or otherwise degrade. The coating composition may be cured at temperatures ranging from 80° C. to 120° C. where neither the first component nor the second component would deform, distort, or otherwise degrade within that range. The coating composition may be cured at temperatures less than or equal to 120° C., less than or equal to 110° C., less than or equal to 100° C., less than or equal to 90° C., or less than or equal to 80° C. where neither the first component nor the second component would deform, distort, or otherwise degrade within these ranges.

Therefore, the coating composition of the present invention may be curable at relatively low temperatures, within the ranges mentioned above, such that components formed from different materials may be simultaneously coated with the coating composition and cured to form a coating thereover without deforming, distorting, or otherwise degrading either component.

The coating composition of the present invention may be applied to the substrate by any suitable means, such as spraying, electrostatic spraying, dipping, rolling, brushing, and the like.

The coating composition of the present invention formed from the coating system can be applied to a substrate to form a pigmented topcoat. The pigmented topcoat may be the topmost coating layer so as not to include a clearcoat or any other coating layer thereover. The pigmented topcoat may be applied directly to the substrate. The pigmented topcoat may be applied over a primer layer or a pretreatment layer.

The coating composition of the present invention can be applied to a substrate as a coating layer of a multi-layer coating system, such that one or more additional coating layers are formed below and/or above the coating formed from the coating composition.

The coating composition of the present invention can be applied to a substrate as a primer coating layer of the multi-layer coating system. A “primer coating layer” refers to an undercoating that may be deposited onto a substrate (e.g., directly or over a pre-treatment layer) in order to prepare the surface for application of a protective or decorative coating system.

The coating composition of the present invention can be applied to a substrate as a basecoat layer of the multi-layer coating system. A “basecoat” refers to a coating that is deposited onto a primer overlying a substrate and/or directly onto a substrate, optionally including components (such as pigments) that impact the color and/or provide other visual impact. A clearcoat may be applied over the basecoat layer

The coating composition of the present invention can be applied to a substrate as a topcoat layer of the multi-layer coating system. A “topcoat” refers to an uppermost coating that is deposited over another coating layer, such as a basecoat, to provide a protective and/or decorative layer, such as the previously described pigmented topcoat.

The topcoat layer used with the multi-layer coating system of the present invention may be a clearcoat layer, such as a clearcoat layer applied over a basecoat layer. As used herein, a “clearcoat” refers to a coating layer that is at least substantially transparent or fully transparent. The term “substantially transparent” refers to a coating, wherein a surface beyond the coating is at least partially visible to the naked eye when viewed through the coating. The term “fully transparent” refers to a coating, wherein a surface beyond the coating is completely visible to the naked eye when viewed through the coating. It is appreciated that the clearcoat can comprise colorants, such as pigments, provided that the colorants do not interfere with the desired transparency of the clearcoat. The clearcoat can be substantially free or free of pigments.

The coating composition of the present invention may be applied over a substrate as a layer in a multi-layer coating system. In the multi-layer coating system, a first basecoat layer may be applied over at least a portion of a substrate, wherein the first basecoat layer is formed from a first basecoat composition. A second basecoat layer may be applied over at least a portion of the first basecoat layer, wherein the second basecoat layer is formed from a second basecoat composition. The second basecoat layer may be applied after the first basecoat composition has been cured to form the first basecoat layer or may be applied in a wet-on-wet process prior to curing the first basecoat composition, after which the first and second basecoat compositions are simultaneously cured to form the first and second basecoat layers.

At least one of the first and second basecoat compositions may be the coating composition of the present invention. The first and second basecoat compositions may be the same composition with both the first and second basecoat compositions comprising the coating composition of the present invention. The first and second basecoat compositions may be different with only one of the first and second basecoat compositions comprising the coating composition of the present invention.

The multi-layer coating system of the present invention may include a primer coating layer formed from a primer composition applied over the substrate. The first basecoat layer may be positioned over at least a portion of the primer coating layer

The multi-layer coating system of the present invention may include a topcoat layer formed from a topcoat composition applied over the substrate. The topcoat composition may be applied over at least a portion of the second basecoat layer. The topcoat may be a clearcoat.

A substrate having a multi-layer coating system of the present invention applied thereover may be prepared by applying a first basecoat composition onto at least a portion of the substrate and applying a second basecoat composition directly onto at least a portion of the first basecoat composition. The first and second basecoat compositions may be cured simultaneously to form first and second basecoat layers. The first and second basecoat compositions may be cured at a temperature of 100° C. or less, such as 80° C. or less, to form the first and second basecoat layers. At least one of the first and second basecoat compositions may comprise the coating composition of the present invention.

Preparing the multi-layer coating system of the present invention may include forming a primer coating layer over at least a portion of the substrate and applying the first basecoat composition onto at least a portion of the primer coating layer.

Preparing the multi-layer coating system of the present invention may include applying a topcoat composition onto at least a portion of the second basecoat composition. The topcoat composition may be applied onto the second basecoat composition prior to or after curing the first and second basecoat compositions. The first basecoat composition, the second basecoat composition, and the topcoat composition may be simultaneously cured at a temperature of 100° C. or less, such as 80° C. or less.

The present invention is also directed to a process for preparing a film-forming thermoset coating composition, comprising: (A) mixing (c1) a component reactive with at least one of the alpha effect based nucleophile functional groups and/or linkages, wherein the component comprises (i) formaldehyde, (ii) polyformaldehyde, (iii) a compound that generates formaldehyde, or a combination thereof with a composition comprising a compound (b1), such as an oligomeric or polymeric compound (b1), comprising a plurality of alpha effect based nucleophile functional groups and/or linkages, (B) aging the mixture provided in step (A) for a time period to form N-methylolated alpha effect based nucleophile functional groups and/or linkages in the compound (b1), such as the oligomeric or polymeric compound (b1), and (C) including the mixture obtained in step (B) into an aqueous medium in order to prepare a film-forming thermoset coating composition comprising an aqueous medium. The plurality of alpha effect based nucleophile functional groups and/or linkages comprise a semi-carbazide functional group and/or linkage, a carbazate functional group and/or linkage, an oxime functional group, an aminoxy functional group and/or linkage, or combinations thereof. Suitable alpha effect based nucleophile functional groups and/or linkages are as described above.

The mixture may be aged in step (B) for at least 1 hour, such as at least 4 hours, such as from 4 to 48 hours, such as from 10 to 24 hours, such as from 1 to 24 hours. The mixture may be aged in step (B) at a temperature of from 20° C. to 70° C., such as from 20° C. to 65° C. or from 20° C. to 60° C. The mixture may be aged in a reaction vessel according to the above-described time and/or temperature conditions, and the aged mixture may be incorporated into a coating formulation comprising other optional materials to form a coating composition.

In the mixture, reactive species (e.g., aldo groups) of the (c1) component reactive with at least one of the alpha effect based nucleophile functional groups and/or linkages may be present in a stoichiometric excess of alpha effect based nucleophile functional groups and/or linkages. In the mixture, the alpha effect based nucleophile functional groups and/or linkages may be present in a stoichiometric excess of the reactive species of (c1) the component reactive with at least one of the alpha effect based nucleophile functional groups and/or linkages, such that not all alpha effect based nucleophile functional groups and/or linkages are reacted therewith. The stoichiometric ratio of reactive species (reactive with the alpha effect based nucleophile functional groups and/or linkages) of (c1) to alpha effect based nucleophile functional groups and/or linkages may be 1:1 or may range from 3:1 to 1:3, such as from 2:1 to 1:2 or from 1.5:1 to 1:1.5.

The present invention is also directed to a process for preparing a film-forming thermoset coating composition, comprising: (A) mixing (c1) a component reactive with at least one of the alpha effect based nucleophile functional groups and/or linkages, wherein the component comprises (i) formaldehyde, (ii) polyformaldehyde, (iii) a compound that generates formaldehyde, or a combination thereof with a composition comprising a compound (b1), such as an oligomeric or polymeric compound (b1), comprising a plurality of alpha effect based nucleophile functional groups and/or linkages in order to prepare a film-forming thermoset coating composition comprising an aqueous medium, and (B) aging the mixture provided in step (A) for a time period to form N-methylolated alpha effect based nucleophile functional groups and/or linkages in the compound (b1), such as the oligomeric or polymeric compound (b1). The plurality of alpha effect based nucleophile functional groups and/or linkages comprise a semi-carbazide functional group and/or linkage, a carbazate functional group and/or linkage, an oxime functional group, an aminoxy functional group and/or linkage, or combinations thereof. Suitable alpha effect based nucleophile functional groups and/or linkages are as described above.

The mixture may be aged in step (B) for at least 1 hour, such as at least 4 hours, such as from 4 to 48 hours, such as from 10 to 24 hours, such as from 1 to 24 hours. The mixture may be aged in step (B) at a temperature of from 20° C. to 70° C., such as from 20° C. to 65° C. or from 20° C. to 60° C. The mixture may be aged in a reaction vessel according to the above-described time and/or temperature conditions, and the aged mixture may be incorporated into a coating formulation comprising other optional materials to form a coating composition.

In the mixture, reactive species (e.g., aldo groups) of the (c1) component reactive with at least one of the alpha effect based nucleophile functional groups and/or linkages may be present in a stoichiometric excess of alpha effect based nucleophile functional groups and/or linkages. In the mixture, the alpha effect based nucleophile functional groups and/or linkages may be present in a stoichiometric excess of the reactive species of (c1) the component reactive with at least one of the alpha effect based nucleophile functional groups and/or linkages, such that not all alpha effect based nucleophile functional groups and/or linkages are reacted therewith. The stoichiometric ratio of reactive species (reactive with the alpha effect based nucleophile functional groups and/or linkages) of (c1) to alpha effect based nucleophile functional groups and/or linkages may be 1:1 or may range from 3:1 to 1:3, such as from 2:1 to 1:2 or from 1.5:1 to 1:1.5.

The present invention is also directed to a process for preparing a film-forming thermoset coating composition, comprising: (A) mixing (c1) a component reactive with at least one of the alpha effect based nucleophile functional groups and/or linkages, wherein the component comprises (i) formaldehyde, (ii) polyformaldehyde, (iii) a compound that generates formaldehyde, or combinations thereof with a composition comprising (b1) a compound, such as an oligomeric or polymeric compound, comprising a plurality of alpha effect based nucleophile functional groups and/or linkages, and (B) aging the mixture provided in step (A) for a time period to form the N-methylolated alpha effect based nucleophile functional groups and/or linkages in the polyurethane-acrylate core-shell particles. The mixture may also comprise other optional materials to form a coating composition. The mixture may include all components intended to be incorporated into the coating composition, such that the whole composition is aged as described below.

The mixture may be aged in step (B) for at least 24 hours, such as at least 48 hours, such as up to 6 months, such as from 24 hours to 6 months, such as from 48 hours to 6 months. The mixture may be aged in step (B) at a temperature of from 20° C. to 70° C., such as from 20° C. to 65° C. or from 20° C. to 60° C. The mixture (e.g., the whole composition) may be aged in a packaging container, such as a packaging container used to sell the coating composition at a retail location.

In the mixture, reactive species (e.g., aldo groups) of the (c1) component reactive with at least one of the alpha effect based nucleophile functional groups and/or linkages may be present in a stoichiometric excess of alpha effect based nucleophile functional groups and/or linkages. In the mixture, the alpha effect based nucleophile functional groups and/or linkages may be present in a stoichiometric excess of the reactive species of (c1) the component reactive with at least one of the alpha effect based nucleophile functional groups and/or linkages, such that not all alpha effect based nucleophile functional groups and/or linkages are reacted therewith. The stoichiometric ratio of reactive species (reactive with the alpha effect based nucleophile functional groups and/or linkages) of (c1) to alpha effect based nucleophile functional groups and/or linkages may be 1:1 or may range from 3:1 to 1:3, such as from 2:1 to 1:2 or from 1.5:1 to 1:1.5.

The coating composition may be used to prepare a coated substrate at low temperatures, such as 100° C. or less or 80° C. or less. The coating composition may be used to prepare a coated substrate at low temperatures by applying the coating composition to a substrate and curing the coating composition at low temperatures to form a coating layer over the substrate (the coated substrate).

### EXAMPLES

The following examples are presented to demonstrate the general principles of the invention. The invention should not be considered as limited to the specific examples presented.

### Example 1

### Preparation of a Resin Having Semi-Carbazide Functionality

### Part A: A Polyurethane Dispersion

A polyurethane was prepared by charging the following components in order into a glass reactor fitted with thermocouple, mechanical stirrer, and condenser under air blanket: 238.3 g of polytetrahydrofuran molecular weight 1000 (Commercially available from BASF (Ludwigshafen, Germany)), 49.5 g of dimethylolpropionic acid, 3.2 g of hydroxyethyl methacrylate, 11.9 g of triethylamine, and 0.5 g of 2,6-di-tert-butyl 4-methyl phenol (commercially available from BASF (Ludwigshafen, Germany)). The mixture was heated to 90° C. and held for 30 minutes. Next, 21.1 g of ethylene glycol dimethacrylate (EGDMA) and 174.2 g of butyl methacrylate (BMA) was charged and temperature was lowered to 50° C. At 50° C., 170.4 g of isophorone diisocyanate was charged into the reactor over 20 minutes. The isocyanate-adding funnel was rinsed with 14.9 g of butyl methacrylate. The temperature of the reaction mixture was held at 80° C. for 2 hours; then the reaction temperature was lowered to 65° C. 90% of the above reaction mixture was charged into a water solution of 829.4 g of deionized water, 24.3 g of hydrazine (35% and commercially available from Sigma Aldrich (Saint Louis, MO)), and 9.7 g of dimethylethanolamine (DMEA), and then mixed and held for 15 minutes to make a polymer dispersion.

### Part B: An Acid-Semicarbazide—Functional Latex

A glass reactor fitted with thermocouple, mechanical stirrer, and condenser under N₂ blanket was charged with 1005.0 g of deionized water, 2.80 g of dimethylethanolamine, 0.33 g of FOAMKILL 649 (commercially available from Crucible Chemical Company (Greenville, SC)), 3.34 g of mercaptopropionic acid (MPA), and 1480.7 g of Part A. Then a mixture of 395.04 g of butyl methacrylate and 80.95 g of EGDMA was charged to the reactor, and then mixed for 10 minutes and heated to 28° C. A mixture of 0.13 grams of t-butylhydroperoxide and 58.32 grams of deionized water was then charged into the flask and mixed for 15 minutes. Next, a mixture of 0.22 grams of ferrous ammonium sulfate, 1.11 grams of sodium metabisulfite, 0.52 g of DMEA and 140.8 grams of deionized water was charged into the flask over 30 minutes. After exothermal, the reaction mixture was cooled to 30° C., then a mixture of 2.31 g of PROXEL GXL commercially available from Arch Biocides (Smyma, GA)) and 2.31 g of deionized water was charged to the reactor. The final dispersion had a Brookfield viscosity (measured according to ASTM D2196 at ambient temperature) of 50.7 centipoise (spindle #2, 60 RPM), a pH (measured herein according to ASTM D4584) of 6.35, and a nonvolatile content of 34.3%. Non-volatile contents (also referred to herein a solids content) were measured by comparing initial sample weights to sample weights after exposure to 110° C. for 1 hour.

### Example 2

### Preparation of a Resin Having Carbazate Functionality

A polyurethane was first prepared by charging the following components in order into a four necked round bottom flask fitted with a thermocouple, mechanical stirrer, and condenser under N₂ blanket: 136.6 grams of PROGLYDE DMM (Commercially available for Dow Chemical Company (Midland, MI)), 14.1 grams of dimethylol propionic acid (DMPA), 93.4 grams of isophorone diisocyanate (IPDI) was charged into the flask and heated to 70° C. At 70° C., 0.5 grams of dibutyl tin dilaurate (DBTDL) was charged into the flask. Immediate exotherm was observed. After exotherm subsided, the mixture was heated to 90° C. and held for 60 minutes until the isocyanate equivalent weight measured was 415.7 eq/g by titration (determined using a Metrohm 888 Titrando; titration by dissolving a sample (˜2.00 g) of the mixture in 30 mL of a solution comprised of 20 mL of dibutylamine and 980 mL of either n-methyl pyrrolidone, followed by titration with 0.2 N HCl solution in isopropanol titration agent). At 90° C., 37.2 grams of Glycerol carbonate (commercially available from InnoSpec (Littleton, CO)) and followed by a rinse with 10.5 grams of PROGLYDE DMM. The mixture was held at 90° C. for 30 minutes. After holding, 15.5 grams of trimethylolpropane (TMP) was added into reaction mixture and the reaction mixture was held at 90° C. until IR spectroscopy showed the absence of the characteristic NCO band. Then, a mixture of dimethylethanolamine (DMEA, 9.4 g) and 35% hydrazine in water (25.3 g) was added into reaction mixture over 30 minutes and followed by a rinse with 17.9 grams of DOWANOL PM (commercially available from Dow Chemical Company (Midland, MI)). The reaction mixture was held at 90° C. until IR spectroscopy showed the absence of the characteristic cyclic carbonate band. Then the reaction temperature was lowered to 70° C. and 314.9 g of DI water (70° C.) was added into reaction mixture over 30 minutes. The final urethane dispersion was held at 70° C. for 30 minutes and then poured out. The final dispersion had a Brookfield viscosity of 118.7 centipoise (spindle #2, 60 RPM), a pH of 7.97, and a nonvolatile content of 26.46%.

### Example 3

### Solvent Resistance and Humidity Tests

The cure response of a keto-functional polymer resin with various alpha effect-based nucleophile crosslinker resins was measured by solvent resistance and humidity resistance methods.

First, the resin was mixed well with either poly-semi-carbazide crosslinker (Example 1) or the polycarbazate crosslinker (Example 2) at a 1:1 keto:nucleophilic group ratio based on resin solids at ambient temperature, keto equivalent weight, and nucleophilic group equivalent weight. The mixture was stirred in a 20 mL glass scintillation vial with a wooden tongue depressor. Once fully blended, the coating composition was allowed to sit under ambient conditions for 1 to 2 hours. The mixture was drawn down over 4 inches by 12 inches steel panels that were pre-coated with an ED 7400 electrocoat (an electrocoat commercially available from PPG Industries Inc. (Pittsburgh, PA)) using a drawdown bar. The panels with wet films were ambient flash for up to 5 minutes before being baked for 30 minutes at 80° C. in an oven. After bake, the panels were taken out of the oven and cooled down to ambient temperature before the Solvent Resistance Test.

The Solvent Resistance Test was performed on each cured coating composition using the following method. Methyl ethyl ketone was used as the solvent for the testing:
1. Place the test panel on a flat table or other suitable flat firm surface.
2. Fold a Wypall brand 03086 wipes commercially available at Kimberly-Clark Professional Inc. (Irving, TX) four times (yielding a section with 8 layers of wipe) and secure over the ball end of a 500-g Ball-Peen hammer. The wipe should be snugly held in place with a rubber band in such a fashion that no wrinkles would be formed.
3. Saturate the cloth with the appropriate solvent for the material being tested, wipe should be re-saturated every 25 double rubs.
4. Immediately rub the saturated wipe over the test area using a back and forth stroke of ˜4-6 inches.
5. Do not exert any downward or upward pressure on the hammer handle. The weight of the hammer controls the downward pressure.
6. Continue this back and forth action counting one “double rub” for each forward and backward motion completed until bare substrate is exposed in the center of the strip where the rubs are performed.
7. Record the test result as the number of double rubs required to expose bare substrate in the center of the rub strip.
8. The area of wipe should be rotated for the next test set. The wipe used for testing should always be rotated to a fresh spot every time a new area is tested, you can typically get 4 test areas on a single wipe.

Cross-hatch adhesion according to the ASTM D3359, test method B was additionally performed on the coated and cured test panels. Adhesion results are assessed on a 0 to 5 scale [0-greater than 65% area removed & 5 is 0% area removed]. In certain instances, the test panels were subjected to a 24 hour water soak at ambient temperature with de-ionized water, removed from the water soak, allowed to recover for 5 minutes, and then tested for solvent resistance and cross-hatch adhesion again.

The coating compositions and results of the testing are shown in Table 1.

TABLE 1

| | Resin and Crosslinker Examples | | | | | | |
|---|---|---|---|---|---|---|---|
| | Ketone- | | | MEK | | After Water | After Water |
| | Functional | Example | Example | double | Cross-hatch | Soak MEK | Soak Cross- |
| Sample | Resin¹ | 1 | 2 | rubs | Adhesion | double rubs | hatch Adhesion |
| CE | 20 | — | — | 30 | 0 | 7 | 0 |
| 3A | | | | | | | |
| 3B | 4.46 | 15.54 | — | 88 | 5 | 55 | 1 |
| 3C | 14.33 | — | 5.67 | 150 | 5 | 150 | 5 |

¹A latex having keto functional core-shell particles as prepared in US 2020/0290086 A1, Example 3

From the MEK double rubs and cross-hatch adhesion data before and after water soak in Table 1, addition of alpha effect-based nucleophiles helps cure and adhere the ketone-containing resin.

### Example 4

### Solvent Resistance

The cure response of a keto-functional polymer resin with various levels of aminoxy crosslinkers was measured by The Solvent Resistance Test.

The coating formulations are listed in Table 2. For each sample, the aminoxy crosslinker was first dissolved in water and further neutralized with 50% dimethylethanolamine (DMEA) solution in a 20 mL glass scintillation vial. The resulting solution was thoroughly mixed by hand using a wooden tongue depressor. Additionally, the aminoxy crosslinker was purchased pre-acidified. To show the effect of a similar amount of acid on the keto-functional resin, Sample 4E was composed of the resin with neutralized hydrochloric acid at a similar amount as the sample at 1:1 keto:aminoxy ratio. The Ketone-Functional Resin was then added to the crosslinker solution and mixed thoroughly throughout the addition of the resin. These mixtures were then allowed to sit under ambient conditions for 1 to 2 hours and further drawn down onto 4″×12″ steel substrate, which was pre-coated with an ED7400 electrocoat primer (available from PPG Industries) and had been processed and baked according to the manufacturer's recommendations. The test panels containing the wet drawndown coating compositions sat at ambient conditions for up to 5 minutes prior to being baked at 80° C. in an oven for 30 minutes. Each coated test panel was allowed to sit at ambient conditions for 20 to 60 minutes prior to conducting the Solvent Resistance Test.

The Solvent Resistance Test was performed on each cured coating composition using the method outlined in Example 3. The coating compositions and results of the testing are shown in Table 2. All material amounts are in grams unless otherwise specified in the table.

TABLE 2

| | Resin and Crosslinker Example | | | | |
|---|---|---|---|---|---|
| | Ketone- | Aminoxy | | | MEK |
| | Functional | Cross- | Acid | Base | double |
| Sample | Resin¹ | linker² | Solution³ | Solution⁴ | rubs |
| CE 4A | 20 | — | — | — | 18 |
| 4B | 19.17 | 0.142 | — | 0.352 | 78 |
| 4C | 18.41 | 0.273 | — | 0.676 | 150 |
| 4D | 17.71 | 0.395 | — | 0.975 | 150 |
| CE 4E | 18.953 | — | 0.370 | 0.677 | 20 |

²O,O′-1,3-Propanediylbishydroxylamine dihydrochloride available from Sigma Aldrich (Saint Louis, MO), Sigma Aldrich product #689122; CAS # 104845-82-1
³A 50% solution of dimethylethanolamine (DMEA)
⁴A 37% solution of hydrochloric acid (HCl)

From the MEK double rubs data in Table 2, addition of alpha effect-based nucleophiles (aminoxy) helps cure the ketone-containing resin.

Whereas particular embodiments of this invention have been described above for purposes of illustration, it will be evident to those skilled in the art that numerous variations of the details of the present invention may be made without departing from the invention as defined in the appended claims.

1. A film-forming thermoset coating composition, comprising:
(a) an aqueous medium; and
Option 1 and/or Option 2 as follows:
Option 1:
(b1) a compound comprising a plurality of alpha effect based nucleophile functional groups and/or linkages; and
(c1) a component reactive with at least one of the alpha effect based nucleophile functional groups and/or linkages, wherein the component comprises (i) formaldehyde, (ii) polyformaldehyde, (iii) a compound that generates formaldehyde, (iv) a polyfunctional ketone, or (v) a polyfunctional aldehyde, or combinations thereof;
Option 2:
(b2) a compound comprising a plurality of n-methylolated alpha effect based nucleophile functional groups and/or linkages,
wherein the plurality of alpha effect based nucleophile functional groups and/or linkages of (b1) and/or (b2) comprise a semi-carbazide functional group and/or linkage, a carbazate functional group and/or linkage, an oxime functional group, or an aminoxy functional group and/or linkage, or combinations thereof.

2. The coating composition of claim 1, wherein the compound comprising a plurality of alpha effect based nucleophile functional groups and/or linkages (b1) and/or the compound comprising a plurality of n-methylolated alpha effect based nucleophile functional groups and/or linkages (b2) is monomeric, oligomeric or polymeric.

3. The coating composition of claim 1, wherein the plurality of alpha effect based nucleophile functional groups and/or linkages of (b1) and/or (b2) comprise at least one of the following structures: 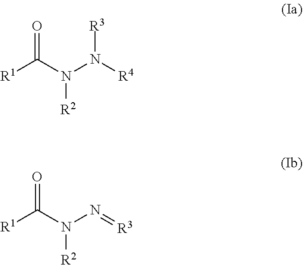
wherein R¹ comprises a nitrogen or oxygen containing group, wherein a nitrogen or oxygen atom of the nitrogen or oxygen containing group is bonded directly to the carbonyl carbon bonded to R¹, wherein R²-R⁴ comprise any moiety, wherein for Option 1 at least one of R², R³, and/or R⁴ is a hydrogen atom in structure (Ia), and wherein R² is a hydrogen atom in structure (Ib) and for Option 2 at least one of R², R³, and/or R comprise a methylol group in structure (Ia), and wherein R² comprises a methylol group in structure (Ib).

4. The coating composition of claim 2, wherein the oligomeric or polymeric compound comprises: polyurethane-acrylate core-shell particles comprising a polymeric acrylic core at least partially encapsulated by a polymeric shell comprising urethane linkages, wherein the polymeric shell comprises an acid functional group and the plurality of alpha effect based nucleophile functional groups and/or linkages and/or n-methylolated alpha effect based nucleophile functional groups and/or linkages, wherein the polymeric shell is covalently bonded to at least a portion of the polymeric core.

5. The coating composition of claim 2, wherein the oligomeric or polymeric compound comprises a polyurethane dispersion and/or a polyacrylic dispersion.

6. The coating composition of claim 1, further comprising:
a polyester polymer obtained from components comprising polytetrahydrofuran and a carboxylic acid or anhydride thereof.

7. The coating composition of claim 6, wherein the polyester polymer comprises a hydroxyl functional group.

8. The coating composition of claim 1, wherein the coating composition comprises Option 1, wherein the component (c1) comprises a melamine-formaldehyde resin, optionally wherein the melamine-formaldehyde resin contains and/or generates formaldehyde in an amount of 0.1 to 3 weight %, based on the total resin solids of the coating composition.

9. The coating composition of claim 1, wherein the coating composition comprises Option 1, wherein the component (c1) comprises the polyfunctional ketone and/or the polyfunctional aldehyde, wherein the coating composition comprises the polyfunctional ketone and/or the polyfunctional aldehyde in an amount of from 3 to 90 weight %, based on the total resin solids of the coating composition.

10. The coating composition of claim 1, wherein the coating composition is a one-component curing composition.

11. The coating composition of claim 1, wherein the coating composition is curable at a temperature of 100° C. or less.

12. The coating composition of claim 1, wherein the coating composition comprises Option 1, wherein the total amount of formaldehyde present and/or generated in (c1) is in the range of 0.1 to 3 weight %, based on total resin solids of the coating composition.

13. The coating composition of claim 1, further comprising an acid catalyst that is a separate component from the compound (b1) and/or (b2), or is covalently bonded to the compound (b1) and/or (b2).

14. The coating composition of claim 4, wherein the polyurethane-acrylate core-shell particles comprise a polyurethane polymer, an acrylic polymer, a polyester polymer, or a combination thereof.

15. The coating composition of claim 4, wherein the polymeric acrylic core comprises an addition polymer formed from (meth)acrylic monomers, vinyl monomers, or a combination thereof.

16. The coating composition of claim 2, wherein the oligomeric or polymeric compound (b1) and/or (b2) comprise internal alpha effect based nucleophile functional groups and/or linkages on the oligomeric or polymeric compound (b1) and/or (b2).

17. The coating composition of claim 13, wherein the acid catalyst comprises carboxylic acid functional groups formed on the oligomeric or polymeric compound (b1) and/or (b2) and which are obtained from a carboxylic acid or anhydride thereof having a pKa of less than 5.5, such as less than 3.

18. The coating composition of claim 17, wherein the carboxylic acid or anhydride thereof comprises trimellitic anhydride.

19. The coating composition of claim 1, wherein the compound (b1) and/or (b2) further comprises internal maleate functional groups.

20. The coating composition of claim 1, wherein the compound (b1) and/or (b2) comprises aliphatic and/or aromatic rings.

21. The coating composition of claim 1, further comprising a polymer reactive with at least one of (b1), (b2), and (c1), wherein the polymer is obtained from components comprising N-(hydroxymethyl)acrylamide, N-(isobutoxymethyl)acrylamide, or a combination thereof.

22. The coating composition of claim 6, wherein the polyester polymer is obtained from components comprising polytetrahydrofuran and a carboxylic acid or anhydride thereof, wherein the polytetrahydrofuran comprises at least 20 weight % of the components that form the polyester polymer and the carboxylic acid or anhydride thereof comprises at least 5 weight % of the components that form the polyester polymer.

23-28. (canceled)

29. A substrate at least partially coated with a coating formed from the coating composition of claim 1.

30. (canceled)

31. The substrate of claim 29, wherein the substrate comprises a vehicle substrate.

32-104. (canceled)
